(19) United States
(12) Patent Application Publication
(10) Pub. No.: US 2007/0081068 A1
(43) Pub. Date: Apr. 12, 2007

(54) IMAGE FORMING APPARATUS

(75) Inventors: Tetsurou NAKAMURA, Fukuoka (JP); Yuuji TOYOMURA, Fukuoka (JP); Yuuzou KAWANO, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/536,072

(22) Filed: Sep. 28, 2006

(30) Foreign Application Priority Data
Oct. 3, 2005 (JP) 2005/289812

(51) Int. Cl. B41J 2/385

(52) U.S. Cl. 347/133

(57) ABSTRACT

An image forming apparatus includes a controller 41setting exposure of organic electro-luminescent elements 63 used as light emitting elements, and exposure sensor units 57 for measuring the exposure of organic electro-luminescent elements 63. The controller 41 sets exposure so that the exposure of the organic electro-luminescent elements 63 when the exposure of the organic electro-luminescent elements 63 is measured is smaller than the exposure when images are formed.

### BACKGROUND OF THE INVENTION

1. Field of the Invention

The present invention relates to an image forming apparatus including exposure devices provided with tight emitting element rows in which a plurality of light emitting elements are arranged in a row, and more particularly to an image forming apparatus that includes exposure devices capable of correcting exposure of the light emitting elements.

2. Description of the Related Art

A so-called image forming apparatus using an electro-photographic method electrically charges photoreceptors with a predetermined electrical potential, and exposes the photoreceptors on the basis of image correction so as to form electrostatic latent images. Then, the image forming apparatus develops the electrostatic latent images by toner, and transfers visualized toner images onto recording paper. After that, image forming apparatus heats the developed electrostatic latent images and fixes the developed electrostatic latent images onto recording paper, thereby obtaining images. The following image forming apparatuses have been known as the image forming apparatus. That is, one of the image forming apparatuses radiates light beans from emitted laser diodes used as light sources on photoreceptors through a rotary multifaceted mirror called as a polygcnal mirror so as to form electrostatic latent images, and the other image forming apparatus individually controls turning on and off of each light emitting unit so as to form electrostatic latent images on photoreceptors by using light emitting element rows in which light emitting elements formed of light emitting diodes (hereinafter, referred to as LEDs) or organic electro-luminescent materials are disposed in a row.

In general, an exposure device including the light emitting element rows as components selectively turns on and off each light emitting element near the photoreceptors, so as to radiate exposure light onto the photoreceptors. In this case, the light emitting element rows include light emitting elements formed of light emitting diodes or organic electro-luminescent materials disposed in a row. For this reason, the image forming apparatus including the exposure devices does not includes a movable unit such as the rotary multifaceted mirror of the image forming apparatus using the laser diodes. As a result, the image forming apparatus has which reliability and silent characteristic. In addition, the image forming apparatus does not need an optical system for guiding light from emitted from the laser diodes to the photoreceptors, and a large optical space used as a light path. Accordingly, it is possible Lo reduce the size of the image forming apparatus.

In particular, the organic electro-luminescent elements and a driving circuit that includes a switching element formed of a thin film transistor (hereinafter, referred to as TFT) on a substrate such as class are integrally formed in the exposure device including the organic electro-luminescent elements as alight emitting elements. Therefore, the structure and manufacturing method of the exposure device are simple, and it is possible to further reduce the size and manufacturing cost as compared to the exposure device including the LEDs as light emitting elements.

However, as the organic electro-luminescent elements are driven, there has occurred a so-called light amount deterioration in which the brightness of tire organic electro-luminescent elements gradually deteriorates. The brightness of the organic electro-luminescent element used in a general display is preferably about 1000 [cd/m². However, for example, when specifications of about 600 dpi (dot/inch) and 20 ppm (pages/minute) are required as Specifications of the image forming apparatus, the brightness of the organic electro-luminescent element used in an exposure device of an image forming apparatus such an electro-photographic apparatus needs to be 10000 [cd/m²] or more. These driving conditions are significantly severe conditions such as a high voltage and large current. For this reason, the organic electro-luminescent element used in an exposure device is more easily affected by the light amount deterioration as compared to the organic electro-luminescent element used in a display. Therefore, it is necessary to correct the exposure so that the exposure of each organic electro-luminescent element is the same as an initial exposure of each organic electro-luminescent element.

In addition, there has been known that the brightness of the organic electro-luminescent element depends on temperature. The temperature dependence characteristic of the brightness is determined depending on organic materials forming the organic electro luminescent clement. As a result, any one of positive and negative temperature dependence characteristics is obtained. Image forming processes of the electro-photographic apparatus include a process for fixing toner images onto recording paper by heat and pressure, and a heat source capable of generating large heat is provided in- the apparatus. Accordingly, as the internal temperature of the image forming apparatus is changed, the brightness of the organic electro-luminescent element is changed. Even In this case, it is necessary to correct the exposure of each organic electro-luminescent element.

In addition, for example, a structure disclosed in JP-A-2004-082330 has been known as an image forming apparatus in the related art, which includes the exposure device using the organic electro-luminescent element, for correcting exposure.

According to an exposure device disclosed in Patent Document 1, light receiving sensors are disclosed on a glass substrate on which organic electro-luminescent elements are formed, and the exposure of each organic electro-luminescent element is detected by -he light receiving sensor

Furthermore, according to JP-A-2004-082330, an exposure Pgn of an n-th organic electro-luminescent element in the exposure device is previously detected by a detection jig. In this case, an exposure Phn in the above-mentioned light receiving sensor is also defected. Then, a correction coefficient Pgn/Phn is calculated on the basis of the detection results, and the correction coefficient is stored in a memory unit provided in the exposure device of the image forming apparatus. After the exposure device is mounted in the image forming apparatus, new driving current of the organic electro-luminescent element is determined on the basis of the exposure detection results detected by the light receiving sensor and the correction coefficient stored in the memory unit, 5 As a result, it is possible to always maintain the initial exposure of the organic electro-luminescent element.

According to JP-A-2004-082330, it is possible to perform an operation for correcting the exposure on the basis of a command of the printer at any time of an initialization operation immediately after the image forming apparatus begins to operate, before printing begins to be performed, and at a paper interval.

FIG. 16 is a view showing the peripheral configuration of a developing station in an image forming apparatus in the related art.

Hereinafter, problems that the Invention is to solve will be described in detail below with reference to FIG. 16.

In FIG. 16, reference numeral 12 indicates a developing station for developing a latent image formed on a photoreceptor 158. Developer 156 that is mixture of carrier and toner is filled in the developing station 152. Reference numerals 157a and 157b indicate agitation paddles for agitating the developer 156. As the agitation paddies 157a and 157b are rotated, the toner in the developer 156 is electrically charged with a predetermined electric potential due to friction between the toner and the carrier. Further, since the toner and the carrier circulate in the developing station 152, the toner and the carrier are sufficiently agitated and mixed to each other.

Reference numeral 158 indicates a photoreceptor used as an image carrier, and the photoreceptor 158 is rotated in a D13 direction by a driving source (not shown) Reference numeral 159 indicates an electric charger, and the electric charger electrically charges the surface of the photoreceptor 158 with a predetermined electric potential. Reference 160 indicates a developing sleeve, and reference 161 indicates a thinning blade. The developing sleeve 160 includes a magnetic roller 162 therein, and the magnetic roller 162 has a plurality of magnetic poles. The thickness of the developer 156 supplied onto the surface of the developing sleeve 160 is controlled by the tinning blade 161, and the developing sleeve 160 is rotated in a D14 direction by a driving source (not shown). The developer 156 is supplied onto the surface of the developing sleeve 160 by the rotation of the developing sleeve 160 and the operation of the magnetic poles of the magnetic roller 162, and an electrostatic latent image formed on the photoreceptor 158 is developed by the exposure device 163 to be described below. Further, the developer 156 that has not been transferred onto the photoreceptor 158 is collected into the developing station 152.

Reference numeral 163 indicates an exposure device. The exposure device 163 includes a light source in which LEDs or organic electro-luminescent elements used as light emitting elements are arranged in a row, and forms an electrostatic latent image having a maximum size of A4 on the basis of image data. When a predetermined electric potential (developing bias) is applied to the developing sleeve 166, an electric potential gradient is generated between a portion laving the electrostatic latent image on the photoreceptor and the developing sleeve 160. Accordingly, a coulomb force is applied to the toner in the developer 156 that is electrically charged with a predetermined electric potential, and the only toner of the developer 156 is attached to the photoreceptor 158, so that the electrostatic latent image is visualized.

Reference numeral 166 indicates a transfer roller. The transfer roller 166 is disposed so as to face the photoreceptor 158 with the recording paper feed path 155 therebetween, and is rotated in a D15 direction by a driving source :not shown). A predetermined transfer bias is applied to the transfer roller 166, and the transfer roller 166 transfers a toner image formed on the photoreceptor 158 onto the recording paper 153 fed along the recording paper feed path 155.

In the image forming apparatus having the above-mentioned structure, when the light emitting element is turned on and off so as to detect the exposure of the light emitting element and correct the exposure, the photoreceptor 156 is ultimately exposed.

Even in an initialization operation immediately after the image forming apparatus begins to operate, before printing begins to be performed, as well as at a paper interval, components of the image forming apparatus used to form images are operated similar to when the images are formed, for example, so as to perform an error checking on the system of the image forming apparatus. Accordingly, the photoreceptors 158 are exposed, are latent images are formed on the photoreceptors 158 regardless of the image formation on the basis of normal image data. These latent images are developed through the above-mentioned processes, and the toner is ultimately attached to the photoreceptors B. When though a developing bias to be applied to the developing sleeves 160 is turned off (that is, a coulomb force for moving the toner onto the photoreceptors is not integrally applied), if a portion on which the latent images are formed, and a portion on which the latent images are not formed exist on the photoreceptors 8 (that is, a coulomb force is applied in the plane direction between a latent image formation region and a non-latent image formation region), an electric potential difference is generated between the portions. Therefore, an excessive difference is generated For this reason, the toner is unnecessarily consumed irregardless of the image formation.

In this way, when the toner attached to the photoreceptors 158 reaches the transfer roller 16, even though a transfer bias is not applied to the transfer roller 16, the surface of the transfer roller 166 is contaminated by a force such as an image force or scratch stress applied when if the transfer roller 16 comes in contact with the toner.

When the transfer roller 166 is contaminated with the toner and the recording paper 153 is fed to the next recording paper feed path 155, a transfer bias is applied to the transfer roller 166 (the transfer bias affects the toner so that the toner moves toward the transfer roller) and the toner is transferred onto the backside of the recording paper 3 by the operation of the scratch stress based on a minute difference between the speed of the recording paper 153 fed along the recording paper feed path 155 and the driving speed of the transfer roller 166. As a result, so-called contamination of the recording paper 153 is generated.

In this case, when a cleaning member is disposed near the transfer roller 166, the surface of the transfer roller 166 can be always cleaned. However, this countermeasure requires the cleaning member and a member for collecting the toner, and increases the cost and the size of the apparatus. For this reason, since the countermeasure cannot prevent the unnecessary consumption of the toner, the countermeasure is not useful,

### SUMMARY OF THE INVENTION

It is an advantage of the invention to provide an image forming apparatus that prevents the unnecessary consumption of toner and the contamination of the recording paper even when light emitting elements such as organic electro-luminescent elements forming the exposure sections emit light so as Lo detect the exposure of the light emitting elements during the time when images are not formed, such as a paper interval of the image forming operation.

The invention has been made to solve the above-mentioned problems, and it is an advantage of the invention to provide an image forming apparatus that includes exposure sections provided with light-emitting elements and exposes image carriers by using the exposure sections so as to form images. The image forming apparatus includes an exposure setting unit that sets exposure of the light emitting elements, and exposure measuring units that measure the exposure of the light emitting elements. The exposure setting unit sets the exposure so that the exposure of the light emitting elements when the exposure of the light emitting elements is measured is smaller than the exposure when images are formed.

According to the image forming apparatus of the invention, even when the light emitting elements forming the exposure sections are turned on and off so as to detect the exposure of the light emitting elements, the exposure setting unit sets the exposure so that the exposure of the light emitting elements is smaller than the exposure when images are formed. For this reason, latent images actually used for development are not actually formed on the photoreceptors. As a result, it is possible to suppress the unnecessary consumption of the toner and to prevent the contamination of the recording paper.

### BRIEF DESCRIPTION OF THE DRAWINGS

FIG. 1 is a view showing the configuration of an image forming apparatus according to a first embodiment of the invention.

FIG. 2 is a view showing the peripheral configuration of a developing station in the image forming apparatus according to the first embodiment of the invention.

FIG. 3 is a view showing the configuration of an exposure device of the image forming apparatus according the first embodiment of the invention.

FIG. 4A is a top view of a glass substrate of the exposure device in the image forming apparatus according to the first embodiment of the invention, and FIG. 4B is an enlarged view of a main part of the glass substrate.

FIG. 5 is a block diagram illustrating the structure of a controller of the image forming apparatus according to the first embodiment of the invention.

FIG. 6 is a diagram illustrating the content of exposure correction data memory of the image forming apparatus according to the first embodiment of the invention.

FIG. 7 is a block diagram illustrating the structure of an engine control unit of the image forming apparatus according to the first embodiment of the invention.

FIG. 8 is a diagram illustrating a positional relationship between exposure sensors forming an exposure sensor unit and organic electro-luminescent elements in the image forming apparatus according to the first embodiment of the invention.

FIG. 9 is a circuit diagram illustrating the exposure device of the image forming apparatus according to the first embodiment of the invention.

FIG. 10 is a diagram illustrating the turn-on period of the organic electro-luminescent element and the current program period of the exposure device in the image forming apparatus according to the first embodiment of the invention.

FIG. 11 is a diagram illustrating the periphery of a developing station of an image forming apparatus according to a second embodiment of the invention.

FIG. 12A is a diagram illustrating the state of an exposure device of the image forming apparatus according to the second embodiment of the invention when an image is formed, and FIG. 12B is a diagram illustrating the state of the exposure device of the image forming apparatus according to the second embodiment of the invention when the amount of light is measured.

FIG. 13 is a block diagram illustrating the structure of an engine control unit of the image forming apparatus according to the second embodiment of the invention.

FIG. 14A is a view showing an exposure device of an image forming apparatus according to a third embodiment of she invention when an image is formed, and FIG. 14B is a view showing -he exposure device of the image forming apparatus according to the third embodiment of the invention when an amount of light is measured.

FIG. 15A is a view showing an exposure device of an image forming apparatus according to a fourth embodiment of the invention when an image is formed, and FIG. 14B is a view showing the exposure device of the image forming apparatus according to the fourth embodiment of the invention when an amount of light is measured.

FIG. 16 is a view showing the peripheral configuration of a developing station in an image forming apparatus in the related art.

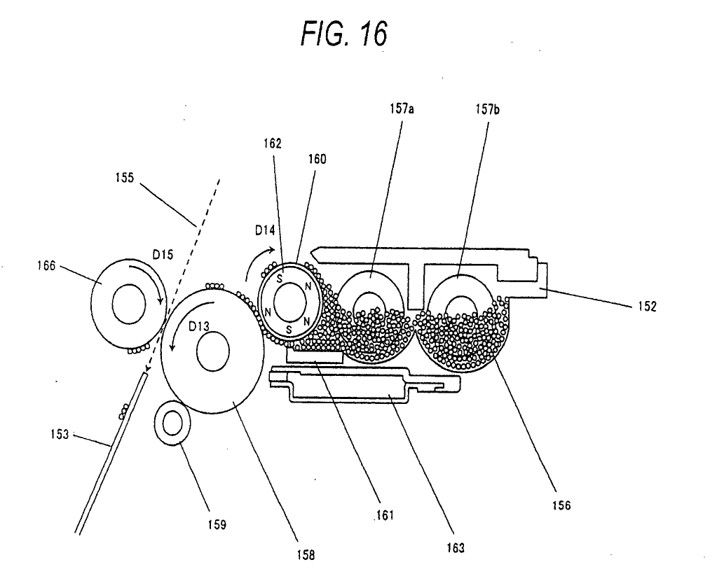

### DESCRIPTION OF THE PREFERRED EMBODIMENTS

According to an embodiment of the invention, an image forming apparatus includes exposure sections provided with light emitting elements and exposes image carriers by using the exposure sections so as to form images. Further, the image forming apparatus includes an exposure setting unit that sets exposure of the the emitting elements, and exposure measuring units that measure the exposure of the light emitting elements. The exposure setting unit sets the exposure so that the exposure of the light emitting elements when the exposure of the light emitting elements is measured is smaller than the exposure when images are formed. Accordingly, even when the light emitting elements forming the exposure sections are turned on and off so as to detect the exposure or the light emitting elements the exposure setting unit sets the exposure so that the exposure of the light emitting elements is smaller than the exposure when images are formed. For this reason, images (latent images and toner images) are not actually formed on the image carriers. As a result, it is possible to suppress the unnecessary consumption of the toner and to prevent the contamination of the recording paper.

Further, according to another aspect of the invention, an image forming apparatus includes photoreceptors as image carriers on which latent images are formed by the exposure of exposure sections, and developing units that develop the latent images formed on the photoreceptors so as to visualize the latent images. In addition, the image forming apparatus includes an exposure setting unit that sets exposure of the light emitting elements, and exposure measuring units that measure the exposure of the light emitting elements. The exposure setting unit sets the exposure so that the exposure of the light emitting elements when the exposure of the light emitting elements is measured is smaller than the exposure used to develop the latent images formed on the photoreceptors. Accordingly, even when the light emitting elements forming the exposure sections are turned on and off so as to detect the exposure of the light emitting elements, latent images used to develop images are not actually formed on the photoreceptors. For this reason, even though the exposure of the light emitting elements is measured, the toner on the photoreceptors is not developed. As a result, it is possible to suppress the unnecessary consumption of the toner and to prevent the contamination of the recording paper.

Further, in the above-mentioned apparatus, a bias potential applied to the developing units is turned off in regions of the photoreceptors exposed during a measuring period that measures the exposure of the light emitting elements. Accordingly, it is possible to reliably suppress the unnecessary consumption of the toner and to prevent the contamination of the recording paper.

In the above-mentioned apparatus, the exposure sections include light emitting element rows in which a plurality of light emitting elements is arranged in a row. For this reason, since the space required to perform exposure is reduced as compared to, for example, a laser printer, it is possible to reduce the size of the image forming apparatus

The above-mentioned apparatus further includes an exposure correction unit that corrects the exposure of the light emitting elements so as to be substantially equal to each other on the basis of measurement results of the exposure measuring units. The exposure setting unit sets an exposure of each light emitting element when images are formed, on the basis of an output of the exposure correction unit. For this reason, since the amount of light emitted from the light emitting elements forming the exposure sections becomes uniform, it is possible to obtain high definition images.

In the above-mentioned apparatus, when images are Formed on a plurality of pages and the exposure of the light emitting elements is measured during a period corresponding to an interval between the pages, the exposure of several light emitting elements among the plurality of light emitting elements provided in the exposure sections is measured. For this reason, even though the paper interval between pages is short, it is possible to ensure a sufficient period for measurement and to accurately detect the exposure of the light emitting elements in this case, since the light emitting elements discretely emit light, the latent images are isolated, which makes it difficult to develop the latent images.

In the above-mentioned apparatus, the light emitting elements include organic electro-luminescent elements. Since the organic electro-luminescent elements can be formed on the substrate through relatively simple processes together with the driving circuit, it is possible to manufacture the organic electro-luminescent elements at low cost. As a result, it is possible to reduce the manufacturing cost of the exposure sections, and to inexpensively provide the image forming apparatus.

In the abovementioned apparatus, when images are not formed, the exposure of the light emitting elements is measured by the exposure measuring units. The t-me when the images are not formed means the time when images on the photoreceptors are not formed, such as a point of initialization of the image forming apparatus or paper interval between sheets of recording paper when the images are formed on several pages. Even though the exposure is measured, the productivity of image formation does not deteriorate and paper can be printed at high speed.

In the above-mentioned apparatus, when images are formed on several pages, the exposure of the light emitting elements is measured during a period corresponding to an interval between the pages. Even though the amount of light emitted from the light emitting elements is changed in a short time due to the temperature rise of the light emitting elements or the temperature rise of the image forming apparatus, it is possible to correct the exposure in real-time.

The above-mentioned apparatus further includes an instruction input unit that inputs Laser's instruction. The exposure of the light emitting elements is measured on the basis of a user's instruction inputted through the instruction input unit. Accordingly, even when sudden environmental changes occur so that the exposure correction cannot follow the changes, it is possible to maintain the high definition.

In addition, according to another aspect of the invention, an image forming apparatus includes exposure sections provided with light emitting element rows in which a plurality of light emitting elements are arranged in a row and exposes image carriers by using the exposure sections so as to form images. Further, the image forming apparatus includes exposure measuring units that measure an amount of light emitted from organic electro-luminescent elements, and image formation suppressing units that suppress formation of the latent images on; the image carriers when the exposure measuring units measure the amount of light emitted from organic electro-luminescent elements. Accordingly, even when the organic electro-luminescent elements forming the exposure sections are turned on and off so as to detect the amount of light emitted from the organic electro-luminescent elements, the image formation suppressing units suppress formation of the latent images on the image carriers. As a result, it is possible to suppress she unnecessary consumption of the toner and to prevent the contamination of the recording paper.

In the above-mentioned apparatus, the image carriers are photoreceptors, and the image formation suppressing units suppress the formation of the latent images, which is performed by the exposure sections, on the photoreceptors. Accordingly, even when the organic electro-luminescent elements forming the exposure sections are turned on and off so as to detect the amount of light emitted from the organic electro-luminescent elements, the image formation suppressing units suppress formation of the latent images on the photoreceptors. For this reason, toner images are not formed on the photoreceptors, and it is possible to suppress the unnecessary consumption of the toner and to prevent the contamination of the recording paper.

In the above-mentioned apparatus, the image formation suppressing units are movably disposed between the exposure sections and the photoreceptors, and include light shielding members for shielding the light emitted from the exposure sections. Accordingly, even when the organic electro-luminescent elements forming the exposure sections are turned on and off so as to detect the amount of light emitted from the organic electro-luminescent elements, the light shielding members suppress the formation of latent images on the photoreceptors. For this reason, the toner images are not formed on the photoreceptors, and it is possible to suppress the unnecessary consumpting of the toner and to prevent the contamination of the recording paper.

In the above-mentioned apparatus, the light shielding members include shutters that move mechanically. Accordingly, it is possible to prevent the photoreceptors from being exposed by the light emitted from the exposure sections, with simple structure.

In the above-mentioned apparatus, the light shielding members include shutters of which light; transmittance is electrically controlled. Accordingly, it is possible to prevent the photoreceptors from being exposed by the light emitted from the exposure sections, with simple structure. In addition, since the structure of the apparatus is simplified, it is possible to prevent the peripheral configuration of the exposure sections from being complicated.

In the above-mentioned apparatus, the image formation suppressing units include light-path length adjusting members that change lengths of the light-paths between the exposure sections and the photoreceptors. Accordingly, the light emitted from the exposure sections does not form images on the photoreceptors. As a result, it is possible to suppress the formation of the latent images on the photoreceptors.

In the above-mentioned apparatus, the light-path length adjusting members change distances between the exposure sections and the photoreceptors in a light axial direction of the light emitted from the exposure sections. Accordingly, the light emitted from the exposure sections does not form images on the photoreceptors due to the simple structure. As a result, it is possible to suppress the formation of the latent images on the photoreceptors.

In the above-mentioned apparatus, the light-path length adjusting members change angles between the photoreceptors and an axis of the light emitted from the exposure sections. Accordingly, the light emitted from the exposure sections does not form images on the photoreceptors due to, for example, the simple structure in which the angles of the exposure sections are chanced. As a result, it is possible to suppress the formation of the latent images on the photoreceptors.

The above-mentioned apparatus further includes an exposure setting unit that sets an amount of light emitted from the organic electro-luminescent elements. The exposure setting unit sets the amount of light so that the amount of light emitted from the light emitting elements when the amount of light emitted from the light emitting elements is measured is smaller than the amount of light when images are formed. Accordingly, even when the organic electro-luminescent elements forming the exposure sections are turned on and off so as to detect the amount of light emitted from the organic electro-luminescent elements, the exposure setting unit sets the exposure so that the exposure of the light emitting elements is smaller than the exposure when images are formed, and suppress the formation of the latent images on the photoreceptors. For this reason, images are not actually formed on the photoreceptors. As a result, it is possible to suppress the unnecessary consumption of the toner and to prevent the contamination of the recording paper.

### First Embodiment

Hereinafter, a first embodiment of the invention will be described with reference to accompanying drawings.

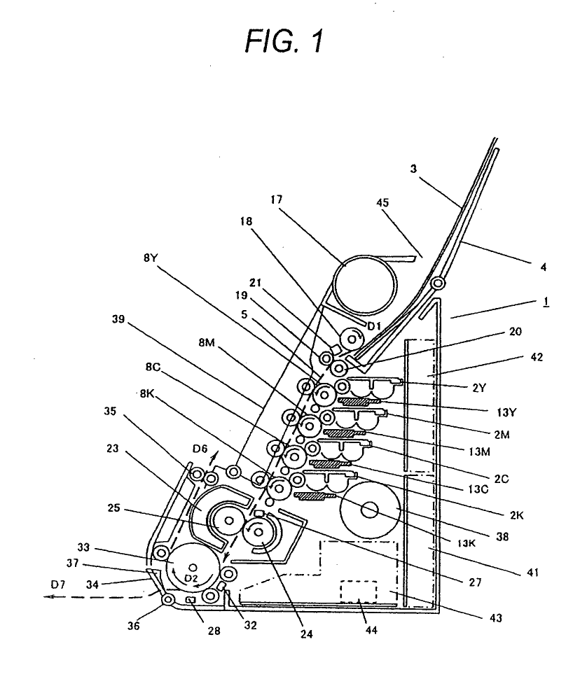

FIG. 1 is a view showing the configuration of ant image forming apparatus according to a first embodiment of the invention.

As shown in FIG. 1, an image forming apparatus 1 includes four color developing stations, a paper feed tray 4, and a recording paper feed path 5. The four color developing stations are composed of a yellow developing station 2Y, a magenta developing station 2M, a cyan developing station 2C, and a black developing station 2K, and are disposed stepwise in a longitudinal direction. The paper feed tray 4 stores recording paper 3 therein, and is disposed on the upper side of the color developing stations. Further, the recording paper feed path 5 serves as a path for the recording paper 3 fed from the paper feed tray 4, and is formed in the longitudinal direction, that is, from the upper side to the lower side, so as to correspond to each of the developing stations 2Y to 21K.

The developing stations 2Y to 2K form a yellow toner image, a magenta toner image, a cyan toner image, and a black toner image, respectively, in this order from the upstream portion of the recording paper feed path 5. The yellow developing station 2Y includes a photoreceptor 8Y, the magenta developing station 2M includes a photoreceptor 8M, the cyan developing station 2C includes a photoreceptor 8C, and the black developing station 2K includes a photoreceptor 8K. Further, each of the developing stations 2Y to 2K includes members, which are used in a series of developing processes of an electro-photographic method, such as a developing sleeve and an electric charger to be described below.

Exposure devices 13Y, 13M, 13C, and 13K that expose the surfaces of the photoreceptors 8Y to 2K to electrostatic latent images are disposed on the lower side of the developing stations 2Y to 2K, respectively.

Even though developers filled in the developing stations 2Y to 2K have different colors, the developing stations 2Y to 2K have the same the configuration. Accordingly, except for when a color needs to be particularly clarified, a specific color will be not described for the purpose of simplicity of the description like developing stations 2, a photoreceptors 8, and exposure devices 13.

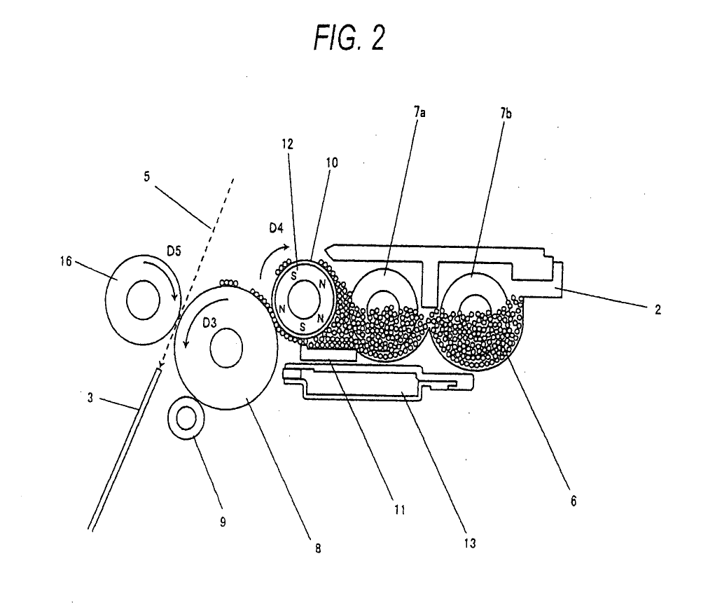

FIG. 2 is a view showing the peripheral configuration of one developing station 2 in the image forming apparatus 1 according to the first embodiment of the invention. In FIG. 2, a developer 6 that is a mixture of carrier and toner is filled in the developing station 2. Reference numerals 7a and 7b indicate agitation paddles for agitating the developer 6. As the agitation paddles 7a and 7b are rotated, the toner in the developer 6 is electrically charged to have a predetermined electric potential due to friction between the toner and the carrier. Further, since the toner d and the carrier circulate in the developing station 2, the toner and the carrier are sufficiently agitated and mixed to each other. The photoreceptor 9 is rotated in a D3 direction by a driving source (not shown). Reference numeral 9 indicates an electric charger, and the electric charger electrically charges the surface of the photoreceptor 8 with a predetermined electric potential. Reference 10 indicates a developing sleeve, and reference 11 indicates a thinning blade. The developing sleeve 10 includes a magnetic roller 12 therein, and the magnetic roller 12 has a plurality of magnetic poles. The thickness of the developer 6 supplied onto the surface of the developing sleeve 10 is controlled by the thinning blade 11, and the developing sleeve 10 is rotated in a D4 direction by a driving source (not shown). The developer 6 is supplied onto -he surface of the developing sleeve 10 by the rotation of the developing sleeve 10 and the operation of the magnetic poles of the magnetic roller 12, and an electrostatic latent image formed on the photoreceptor 8 is developed by the exposure device 13 to be described below. Further, the developer 6 that has not been transferred onto the photoreceptor 8 is collected into the developing station 2.

Reference numeral 23 indicates an exposure device. The exposure device 13 according to the first embodiment includes a light emitting element row in which organic electro-luminescent elements used as light sources for exposure are arranged in a row to have a resolution of 600 dpi (dot per inch). The exposure device 13 turns on/off the organic electro-luminescent elements on the basis o: the image data so as to selectively radiate light onto the photoreceptor e that is charmed by the electric charger 9 with a predetermined potential, thereby forming an electrostatic latent image having a maximum size of A4. The only toner of the developer 6 supplied on the surface of the developing sleeve 10 is attached to the electrostatic latent image, so that the electrostatic latent image is visualized.

As described in detail below, the exposure device 13 is provided with an exposure sensor unit as an exposure measuring unit that measures exposure of the organic electro-luminescent elements.

Reference numeral 16 indicates a transfer roller. The transfer roller 16 is disposed so as to face the photoreceptor 8 with the recording paper feed path 5 therebetween, and is rotated in a D5 direction by a driving source (not shown) A predetermined transfer bias is applied Lo the transfer roller 16, and the transfer roller 16 transfers a toner image formed on the photoreceptor 8 onto the recording paper 3 fed along the recording paper feed path 5.

Hereinafter, the first embodiment of the invention will be described again with reference to FIG. 1.

Reference numeral 17 indicates a toner bottle, and yellow, magenta, cyan, and black toners are stored in the toner bottle. Toner supplying pipes (not shown) are provided between the toner bottle 17 and the developing stations 2Y and 2K so that toner is supplied to each of the developing stations 2Y and 2K.

Reference numeral 18 indicates a paper feed roller. When an electromagnetic clutch (not shown) is controlled, the paper feed roller 18 is rotated in the D1 direction, so that the recording paper 3 loaded in the paper teed tray 4 is sent to the recording paper reed path 5.

A resist roller 19 and a pinch roller 20 are provided in a pair on the recording paper feed path 5, which is disposed between the paper feed roller 18 and a transferring portion of the uppermost that is, yellow) developing station 2Y, as an inlet nip feeding unit. The pair of the resist roller 19 and the pinch roller 20 temporarily stops the recording paper 3 fed by the paper feed roller 18, and feeds the recording paper 3 toward the yellow developing station 2Y at a predetermined time. The front end of the recording paper 3 is controlled to be parallel with an axial direction of the pair of resist roller 19 and the pinch roller 20, through the temporary stop of the recording paper 3. As a result, it is possible to prevent the recording caper 3 from passing obliquely.

Reference numeral 21 indicates a recording paper passage detecting sensor The recording paper passage detecting sensor 21 includes a reflective sensor (photoreceptor), and detects the front end rear ends of the recording paper 3 on the basis of whether the reflected light exists.

When an electromagnetic clutch (not shown) controls power transmission such that the resist roller 19 begins to be rotated, the recording paper 3 is sent toward the yellow developing station 2Y along the recording paper feed path 5. However, the time when the exposure devices 13Y to 13K disposed near the developing stations 2Y to 2K write the electrostatic latent images, turning on and off of a developing bias, turning on and off of the transfer bias, and the like are independently controlled from time when the resist roller 19 begins to be rotated.

Hereinafter, the first embodiment of the invention will be described with reference to FIG. 2.

A distance between the exposure device 13 shown in FIG. 2 and a developing region (the vicinity of a portion where a gap between the photoreceptor 8 and the developing sleeve 10 is narrowest) is a design parameter. Accordingly, for examples the time until when the latent image is formed on the photoreceptor 8 through she exposure of the exposure device 13 and then reaches the developing region is also a design parameter.

In the first embodiment, the following control is performed. That is, in the above-mentioned control, when several pages of the recording paper are successively printed as described below from the time when the resist roller 19 begins to he rotated, the exposure of the organic electro-luminescent elements forming the exposure device 13 is set and the organic electro-luminescent elements are turned on at an interval (that is, paper interval) between sheets of recording paper fed along the recording paper feed path 5, and a developing bias is turned off at a latent image position on the photoreceptor 8.

Hereinafter, the first embodiment of the invention will be described again with reference to FIG. 1.

A photographic fixing unit 23 is provided on the recording paper feed path 5, which is disposed on the lower side of the lowermost (that is, black) developing station 2K, as an outlet nip feeding unit. The photographic fixing unit 23 includes a heating roller 24 and a pressing roller 25.

Reference numeral. 27 indicates a temperature sensor for detecting the temperature of the heating roller. The temperature sensor 27 is a ceramic semiconductor that is formed of metal oxide as a main material and is obtained by sintering at a high temperature. The temperature sensor 27 uses characteristic in which load resistance is changed depending on temperature, so as to be able to detect the temperature of an object coming in contact with the temperature sensor. The output of the temperature sensor 27 is input to an engine control unit 42 to be described below. The engine control unit 42 controls electric power to be supplied to a heat source (not shown, which is provided in the heating roller 24, on the oasis of the output of the temperature sensor 27 so that the heating roller 24 has a surface temperature of about 170° C.

When the recording paper 3 having a toner image enters the nip portion formed by the pressing roller 25 and the heating roller 24 of which temperature is controlled, the toner image formed on the recording paper 3 are heated and pressed by the heating roller 24 and the pressing roller 25. As a result, the toner image is fixed on the recording paper 3.

Reference numeral 28 indicates a recording paper rear end detecting sensor, and the recording paper rear end detecting sensor monitors whether the rear end of the recording paper 3 is discharged. Reference numeral 32 indicates a toner image detecting sensor. The toner image detecting sensor 32 is a reflective sensor unit that includes a plurality of light emitting elements having different emission spectrums (all are visible light) and a light receiving element. The toner image detecting sensor 32 uses characteristic in which an absorption spectrum is different depending on image colors at the background and the portion having an image of the recording paper 3 so as to detect an image density. Further, the toner image detecting sensor 32 can detect the position of the image as well as an image density. Accordingly, the image forming apparatus 1 according to the first embodiment includes two toner image detecting sensors 32 provided thereto in the width direction, so that an image forming time is controlled on the basis of a detection position of an image positional deviance detecting pattern formed on the recording paper 3.

Reference numeral 33 indicates a recording paper feed drum. The recording paper feed drum 33 is a metal roller covered with rubber having a thickness of about 200 μm. After the toner image is fixed on the recording paper 3, the recording paper 3 is fed in a D2 direction along the recording paper feed drum 33. In this case, the recording paper 3 is cooled by the recording paper feed drum 33, and is reversely bent and fed. Accordingly, it Is possible to significantly reduce curl occurring when the high dense image is formed on entire surface of the recording paper. After that, the recording paper 3 is fed in a D6 direction by a discharging roller 35, and discharged to a paper discharge tray 39.

Reference numeral 34 indicates a face-down paper discharging unit. The face-down paper discharging unit 34 can be rotated about a supporting member 36. When the face-down paper discharging unit 34 is open, the recording paper 3 is fed in a D7 direction. A rib 37 is formed along a paper feeding path on the inner surface of the face-down paper discharging unit 34 so as to guide the recording paper 3 together with the recording paper feed drum 33 when the face-down paper discharging unit 34 is closed.

Reference numeral 38 indicates a driving source. A stepping motor is used as the driving source 38 in the first embodiment. Peripheral sections of each of the developing stations 2Y to 2K that include the paper feed roller 18, the resist roller 19, the pinch roller 20, the photoreceptor 8Y to 8K, and the transfer roller 16 (see FIG. 2), the photographic fixing unit 23, the recording paper feed drum 33, and the discharging roller 35 are driven by the driving source 38.

Reference numeral 41 indicates a controller. The controller receives image data from a computer (not shown) or the like through an external network, and expands and generates printable image data. As described in detail below, a controller CPU (not shown) provided in the controller 41 serves as both an exposure correction unit that receives exposure measurement data of the organic electro-luminescent elements used as light emitting elements from the exposure devices 13Y to 13K and generates exposure correction da-a, and an exposure setting unit that sets the exposure of the organic electro-luminescent elements on the basis of the exposure correction data.

Reference numeral 42 indicates an engine control unit. The engine control unit 42 controls the hardware or mechanism or the image forming apparatus 1, and forms color images on the recording paper 3 on the basis of the image data and exposure correction data transmitted from the controller 41. Further, the engine control unit 42 performs entire control of the image forming apparatus 1 that includes temperature control of the heating roller 24 of the above-mentioned photographic fixing unit 23.

Reference numeral 43 indicates a power supply unit. The power supply unit 43 supplies predetermined electric power to the exposure devices 13Y to 13w, the driving source 38, the controller 41, the engine control unit 42, and supplies electric power to the heating roller 24 of the photographic fixing unit 23. In addition, the power supply unit also includes a so-called high voltage power supply unit of a charging electric potential for charging the surface of the photoreceptor 8, a developing bias applied to -he developing sleeve (see FIG. 2), a transfer bias applied to the transfer roller 16, and the like. The engine control unit 42 controls the power supply unit 43, and thus adjusts an output voltage value or output current value as sell as turning on and off of the high voltage power supply unit.

Further, the power supply unit 43 includes a power monitoring unit 44. The power monitoring unit 44 monitors at least a voltage supplied to the engine control unit 42 and the output voltage of the power supply unit 43. The monitoring signals are detected by the engine control unit 42, so that the voltage reduction occurring when the power switch is turned off or electric power is interrupted, in particular, an abnormal output of the high voltage power supply unit is detected.

The operation of the image forming apparatus 2 configured as described above will be described with reference to FIGS. 1 and 2.

In the following description, the entire configuration and operation of the image forming apparatus 1 will be described mainly with reference to FIG. 1, and components will be described so as to distinguish colors thereof like the developing stations 2Y to 2K, the photoreceptors 8Y to 8K, and the exposure devices 13Y to 13K. However, monochromatic processes such as exposure or development processes will be described mainly with reference to FIG. 2, and components will be described without distinguishing colors thereof like the developing station 2, the photoreceptor 8, and the exposure device 13.

<Initialization Operation>

First, initialization operation when electric power is supplied to the image forming apparatus 1 will be described.

When the electric power is supplied to the image forming apparatus 1, an engine control CPU (not shown) provided in the engine control unit 42 performs an error checking of the electric resources forming the image forming apparatus 1, that is, a resistor capable of reading/writing, memory, and the like. When the error checking is completed, the engine control CPU (not shown) begins to rotate the driving source 38. As described above, the peripheral sections of each of the developing stations 2Y to 2K that include the paper feed roller 18, the resist roller 19, the pinch roller 20, the photoreceptor 8Y to 8K, and the transfer roller 16, the photographic fixing unit 23, the recording paper feed drum 33, and the discharging roller 35 are driven by the driving source 38. However, immediately after the electric power is supplied to the image forming apparatus 1, an electromagnetic clutch (not shown) for transmitting a driving force to the paper teed roller is and the resist roller 19 is immediately set to be turned off, so that the paper feed roller 18 and the resist roller 19 used to feed the printing paper 3 are controlled not to feed the printing paper 3.

Hereinafter, the initialization operation will be described with reference to FIG. 2.

As the driving source 38 (see FIG. 1) is rotated, the agitation paddles 7a and 7b and the developing sleeves 10 of the developing stations 2 begin to be rotated. As a result, the developer 6 formed of toner and carrier circulates in the developing stations 2, and the tonier is electrically charged to have a negative charge due to friction between the toner and the carrier.

The engine control CPU (not shown) begins to rotate the driving source 38 (see FIG. 1). Then, after a predetermined time has passed, engine control CPU controls the power supply unit 43 (see FIG. 1) so as to turn on and off the electric charger 9. The surfaces of the photoreceptors 8 are electrically charged by the electric chargers 9 with an electric potential of, for example, −700 V. The photoreceptors 8 are rotated in the D3 direction. Then, after a charging region reaches the developing region, that is, the position closest to the photoreceptors 8 and the developing sleeves 10, the engine control CPU (not shown) controls the power supply unit 43 (see FIG. 1) and applies a developing bias of, for example, −400 V to the developing sleeves 10. In this case, the electric potential of the surfaces of the photoreceptors 8 is −700 V, and the developing biases applied to the developing sleeves 10 are −400 V. Accordingly, an electric line force is formed from the developing sleeves 10 toward the photoreceptors 8, and a coulomb force affected to the toner having a negative charge is applied from the photoreceptor 8 to the developing sleeve 10. As a result, the toner is not attached to the photoreceptor 8.

As described above, the power supply unit 43 (see FIG. 1) has a function to monitor an abnormal output of the high voltage power supply unit, and the engine control CPU (not shown) can check the abnormality when a high voltage is applied to the electric charger 9 or the developing sleeve 10.

At the end of the series of the initialization operation, the engine control CPU (not shown) corrects she exposure of the exposure device 13. The engine control CPU (not shown) provided in the engine control unit 42 (see FIG. 1) outputs a request for generation of exposure correction time information to the controller 41 (see FIG. 1). The controller 41 (see FIG. 1) generates th,e exposure correction time information on the basis of the request for generation, and the organic electro-luminescent elements forming the exposure device 13 are actually controlled to be turned on at the time of the initialization on the basis of the exposure correction time information. In the first embodiment, the exposure of the organic electro-luminescent elements is measured by the exposure sensor units (not shown) provided in the above-mentioned exposure devices 13 in synchronization with the control of turning on of the organic electro-luminescent elements (specifically, on the basis of the management performed by the engine control CPU (not shown)). Then, the exposure of the organic electro-luminescent elements is corrected so as to be substantially equal to each other on the basis of the result of the exposure measurement. As described above, while units used to form images such as the photoreceptors 8 or the developing stations 2Y to 2K of the image forming apparatus 1 are driven/ the exposure measurement performed. As a result, if the exposure measurement is performed while the photoreceptor 8 is stopped, the same portion if the photoreceptor 8 is continually exposed, that is, the same portion of the photoreceptor 8 i s excessively exposed. Accordingly, the characteristic of the photoreceptor 8 partially deteriorates. It is necessary to perform the exposure measurement while at least photoreceptor 8 is rotated and electrically charged by the electric charger 9 to prevent the toner from being attached to the photoreceptor 8.

As described in detail below, the image forming apparatus 1 according to the embodiment of the invention includes exposure devices 13 as exposure sections that includes light emitting elements organic electro-luminescent elements), and exposes the photoreceptors 8 used as image carriers by using the exposure devices 13 so as to form images. The image forming apparatus 1 includes an exposure setting unit (the controller CPU provided in the controller 41) that sets the exposure of the light emitting elements (the organic electro-luminescent elements), and exposure measuring units (the exposure sensor units provided in the exposure devices 13). The exposure setting unit (the controller CPU provided in the controller 41) sets the exposure of the light emitting elements (the organic electro-luminescent elements) so that the exposure when the exposure of the light emitting elements (the organic electro-luminescent elements) is measured is smaller than -he exposure when the images are formed.

That is, the image forming apparatus 1 includes an exposure setting unit (controller CPU) that sets an amount of light emitted from the organic electro-luminescent elements, and the exposure setting unit sets the amount of light emitted from the light emitting elements (the organic electro-luminescent elements) so that the amount of light emitted from the light emitting elements when the exposure of the organic electro-luminescent elements is measured is smaller than that when the images are formed.

As a result, the exposure setting unit controls the latent images that are formed on the photoreceptor.

Further, the image forming apparatus 1 according to the embodiment of the invention includes exposure devices 13 as exposure sections that includes light emitting elements (organic electro-luminescent elements), photoreceptors 8 on which latent images are formed by the exposure devices 13, developing units (developing sleeves 10 included in the developing stations 2) that develop the latent images formed on the photoreceptors 8 so as to visualize the latent images. As described in detail below, the image forming apparatus 1 also includes an exposure setting unit (the controller CPU provided in the controller 41) that sets exposure of the light emitting elements (the organic electro-luminescent elements), exposure measuring units (the exposure sensor units provided in the exposure devices 13). The exposure setting unit (the controller CPU provided in the controller 41) sets the exposure of the light emitting elements (the organic electro-luminescent elements) so that the exposure when the exposure of the light emitting elements (the organic electro-luminescent elements) is measured is smaller than the exposure when the latent images formed on the photoreceptors 8 are developed. As a result, the exposure is set so that the developing units (developing sleeves 10 included in the developing stations 2) do not develop the latent images formed on the photoreceptors 8.

Further, as described in detail below, in the image forming apparatus 1 according to the embodiment of the invention, the exposure device 13 used as an exposure unit includes a light emitting element row in which a plurality of light emitting elements (organic electro-luminescent elements) are arranged in a row. That is, the exposure device 13 of the first embodiment includes so-called solid exposure elements.

As a result, the organic electro-luminescent elements, which are used as light sources for exposure and forms the exposure device 13, emit light, and the exposure or the organic electro-luminescent elements is measured in the initialization operation of the image forming apparatus 1. Therefore, even though the exposure is corrected, toner is not attached to the photoreceptors a, thereby preventing unnecessary consumption of toner. In additions toner is attached to the transfer rollers 16, which comes in contact with the photoreceptors 8 so as to be rotated. In the image forming operation successive to the initialization operation, the toner attached to the transfer rollers 16 is not attached to the backside of the recording paper 3, thereby preventing contamination of the recording paper 3.

Since the organic electro-luminescent elements are turned on during the exposure correction, the exposed regions of the photoreceptors 8 approach the developing sleeves 10. When the exposed regions of the photoreceptors 8 pass through so-called developing regions, it is preferable that the developing biases applied to the developing sleeves 10 be turned off in the regions of the photoreceptors 8 that are exposed during the measuring period when the exposure of the organic electro-luminescent elements is measured. As a result, it is possible to more effectively prevent the toner from being attached to the photoreceptors 8.

<Image Forming Operation>

Hereinafter, the image forming operation of the image forming apparatus 1 will be described with reference to FIGS. 1 and 2.

When image information is transmitted to the controller 41 from the outside, the controller 41 expands the image information as, for example, printable binary image data into an image memory (not shown). When the image information expansion is completed, the controller CPU (not shown) provided in the controller 41 transmits a start request to the engine control unit 42. The start request is received by an engine control CPU (not shown) provided in the engine control unit 42, and the engine control CPU (not shown) receiving the start request directly rotates the driving source 38 to begin preparing an image formation.

This process is the same as the above-mentioned <Initialization operation> except for the error checking of the electric resources. Even at this time, the engine control CPU (not shown) can measure the exposure. However, as described below, since about 10 seconds are required to measure the exposure, a first time (the time required to initially print the first recording paper) is affected. Accordingly, a user can selectively perform the exposure correction at the time of the start-up by using an operation panel (not shown) or the outside (for example, computer) of the image forming apparatus 1, that is, an instruction input unit that inputs user's instruction.

When the preparation of the image formation is completed through the above-mentioned processes, the engine control CPU (not shown) provided in the engine control unit 42 controls the electromagnetic clutch (not shown) to rotate the paper feed roller 18 so that the recording paper 3 begins to be fed. The paper feed roller 18 is, for example, a half moon roller of which a part of entire periphery is removed, and feeds the recording paper 3 toward the resist roller 19. When the paper feed roller 18 is rotated one time, the paper teed roller 18 is stopped When the recording paper passage detecting sensor 21 detects the front end of the recording paper 3, the engine control CPU (not shown) sets a predetermined delay period and then controls the electromagnetic clutch (not shown) Lo rotate the resist roller 19. As the resist roller is rotated, the recording paper 3 is supplied onto the recording paper feed path 5.

The engine control CPU (not shown) independently controls the time when the exposure devices 13Y to 13K write the electrostatic latent images, from time when the resist roller 19 begins to be rotated. Since the time to write the electrostatic latent images directly affects the color deviance in the image forming apparatus 1, the time to write the electrostatic latent images does not directly cause the engine control CPU (not shown) to affect the color deviance. Specifically, the engine control CPU (not shown) presets the time when the exposure devices 13 write the electrostatic latent images in timers that are hardware (not shown). Then, the operations of the timers corresponding to the exposure devices 13Y to 13K are simlultaneously begun from the time when the resist roller 19 begins to be rotated. When a preset time has passed, each of the timers outputs an image data transmission request to the controller 41.

The controller CPU (not shown) of the controller 41, which receives the image data transmission request, independently transmits the binary image data to each of the exposure devices 13Y to 13K in synchronization with time signals (clock signals, line synchronization signals, and the like) generated by a timing generator (not shown) of the controller 41. As a result, the binary image data is transmitted to the exposure devices 13Y to 13K, and the turning on and off of the organic electro-luminescent elements forming the exposure devices 13Y to 13K is controlled on the basis of the binary image data, thereby exposing the photoreceptors 8 corresponding to colors.

As shown in FIG. 2, the latent images formed by the exposure are visualized by she sooner included in the developer 6 supplied onto the surfaces of the developing sleeves 10. Color toner images visualized by the toner are sequentially transferred onto the recording paper 3 fed along the recording paper feed path 5. The recording paper 3 onto which four-color toner images are transferred is fed Lo the photographic fixing unit 23, and then fed between the heating roller 24 and the pressing roller 25 that form the photographic fixing unit 23. As a result, the toner images are fixed on the recording paper 3 by heat and pressure.

When images are formed on several pages of the recording paper, the rear end of the recording paper is detected by the recording paper passage detecting sensor 21 for each page. Then, the engine control CPU (not shown) temporarily stops the resist roller 19. After predetermined time has passed, the engine control CPU rotates the paper feed roller 18 so that next recording paper 3 begins to be fed. Then, after further predetermined time has passed, the engine control CPU again rotates the resist roller so as to supply the next page of the recording paper to the recording paper feed path 5. The rotation of the resist roller 19 is controlled as described above. Accordingly, when images are formed on the plurality of pages, it is possible to set a paper interval between sheets of recording paper 3. The time Thereinafter, referred to as paper interval time) corresponding to the paper interval is different depending on the image forming apparatus 1, but is generally set about 500 ms. A common image forming operation (that is, the exposing operation that is performed on the photoreceptors 8 by the exposure devices 13) is not performed during the paper interval period.

When images are formed on the plurality of pages, the image forming apparatus 1 according to the embodiment causes the light emitting elements (the organic electro-luminescent elements) forming the exposure devices 13 to emit light at an interval period (paper interval time) corresponding to an interval period between the pages, that is, when images are not formed. Then, the image forming apparatus 1 measures light exposure in synchronization with the light emission. In this case, the exposure is controlled to be smaller than that when the images are commonly formed, as described in <Initialization operation>. As a result, the exposure is set so that the latent images are not developed.

As described above, the paper interval time in the first embodiment is set to about 500 ms. As described in <Initialization operation>, the time required to measure the exposure of all organic electro-luminescent elements is set to about 10 seconds in the first embodiment, which will be described in detail below. It is not possible to measure the exposure of all organic electro-luminescent elements during one paper interval time. Accordingly, when she exposure of organic electro-luminescent elements is measured during the period corresponding to an interval between the pages, the exposure of some of all organic electro-luminescent elements forming the exposure devices 13 is measured in the first embodiment.

Assuming that a paper interval time is set to 500 ms and an exposure measurement time is set to about 10 seconds, it is simply understood that the exposure of all organic electro-luminescent elements forming the exposure devices 13 can be measured while the paper interval occurs 20 times. In a series of printing jobs, the number of pages may be normally set to be larger than that described above. In this case, after the printing jobs are completed (when the image forming apparatus 1 is in a standby state for a printing command), the exposure may be measured.

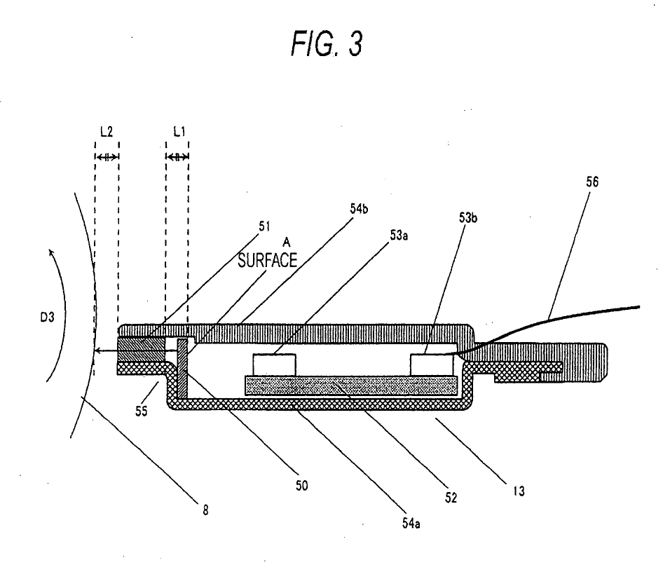

FIG. 3 is a view showing the configuration of the exposure device 13 of the image forming apparatus 1 according -he first embodiment of the invention. Hereinafter, the configuration of the exposure device 13 will be described in detail with reference to FIG. 3. In FIG. 3, reference numeral 50 indicates a colorless and transparent glass substrate. In the first embodiment, a borosilicic acid glass is used as the glass substrate 50. However, when a control circuit, a driving circuit, and the like are formed on the light emitting element or the glass substrate 50 by a thin film transistor, and heat needs to be more effectively radiated from the control circuit, the driving circuit, and the like, glass or quartz including thermal conductivity additive factors such as MgO, Al₂O₃, CaO, ard ZnO may be used as a material of the glass substrate SO.

The organic electro-luminescent elements used as light emitting elements are provided on the surface A of the glass substrate 50 in a direction (main scanning direction) perpendicular to the plane of FIG. 3, so as to have a resolution of 600 dpi (dot per inch). Reference numeral 51 indicates a lens array in which rod-shaped lenses (nut shown) made of plastic or glass are disposed in a row. The Lens array 51 guides light emitted from the organic electro-luminescent elements onto the surface of the photoreceptor 8 so that an erecting image is formed at the same magnification. The positional relationship between the glass substrate 50, the lens array 51, and the photoreceptor 8 is adjusted so that one focus of the lens array 51 is on the surface A of the glass substrate 50 and the other focus is on the surface of the photoreceptor 8. That is, when a distance between the surface A and the surface of the lens array 51 close to the surface A is defined as L1 and a distance between the other surface of the lens array 51 and the photoreceptor 8 is defined as L2, the positional relationship therebetween is set so that L1 is equal to L2.

Reference numeral 52 indicates a relay substrate in which electronic circuits are formed on, for example, a glass epoxy substrate. Reference numeral 53a indicates a connector A, and reference numeral 53 indicates a connector B. At least the connector A 53a and the connector B 53b are mounted on the relay substrate 52. The relay substrate 52 relays image data or exposure correction data supplied from the outside and other control signal to the exposure device 13 through the connector B 53b, and passes these signals to the glass substrate 50.

It is difficult to directly mount the connectors on the surface of the glass substrate 50 in terms of bonding strength or reliability in various environments. Accordingly, in the first embodiment an FPC (Flexible Printed Circuit) (not sown) is used as connecting means for connecting the connector A 53a of the relay substrate 52 with the glass substrate 50, and for example, an ACF (Anisoctropic Conductive Film) is used to connect the glass substrate 50 with the FPC, so that the connectors are directly connected to, for example, ITO (Inidium Tin Oxide) electrodes.

Meanwhile the connector B 53b is a connector used to connect the exposure device 13 to the outside. In general, the connection using the ACF has many problems in bonding strength. However, when a user provides the connector B 53b for connecting the exposure device 13 on the relay substrate 52, it is possible to ensure the sufficient bonding strength in an interface that is directly accessed by a user.

Reference numeral 54a indicates a case A, and the case A is formed by, for example, bending a metal plate. An L-shaped portion 55 is formed on the side of the case A 54a facing the photoreceptor 8. Further, the glass substrate 50 and the lens array 51 are disposed along the L-shaped portion 55. The end surface of the case A 54a facing the photoreceptor 8 and the end surface of the lens array 51 are flush with each other, and one end of the glass substrate SC is supported by the case A 54a. Therefore, when the molding accuracy of the L-shaped portion 55 is ensured, it is possible to accurately adjust the relationship between the glass substrate 50 and the lens array 51. Since the case A 54a should be formed to have high dimension accuracy, it is preferable that the case A 54a be made cf metal. When the case A 54a is made of metal, it is possible to suppress the noise effect on electronic components such as a control circuit formed on the glass substrate 50 and an IC chip surface-mounted on the class substrate 50.

Reference numeral 54b indicates a case B formed by molding a resin. Since a notched portion (not shown) is formed in the case B 54b near the connector B 53b, a user can have access to the connector 53b from the notched portion. Image data, exposure correction data, control signals such as clock signals or line synchronization signals, driving electric power of the control circuit, driving electric power of the organic electro-luminescent elements used as light emitting elements, and the like are supplied to the exposure device 13 from the above-mentioned controller 41 (see FIG. 1) through a cable 56 connected no the connector B 53b.

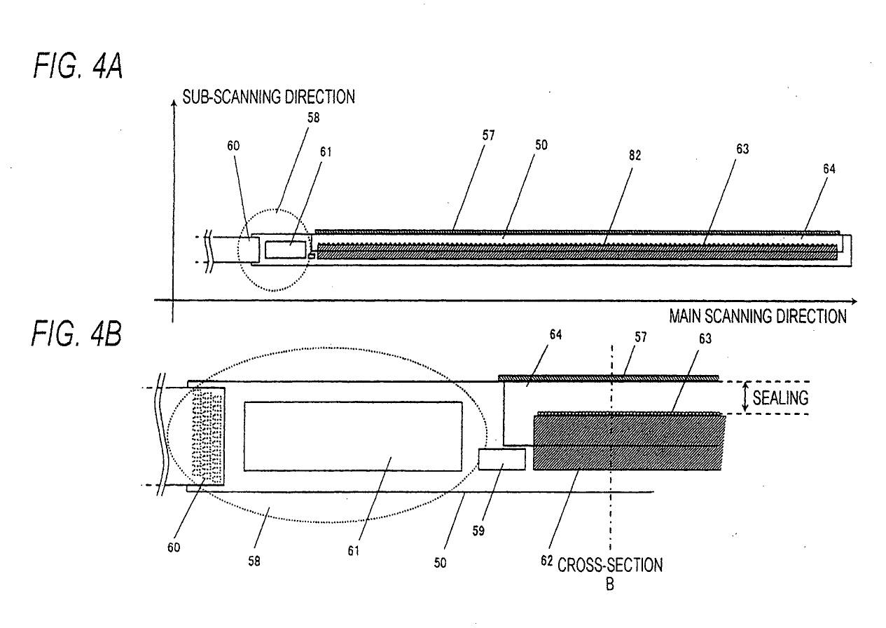

FIG. 4A is a top view of the glass substrate 50 of the exposure device 13 _n the image forming apparatus 1 according to the first embodiment of the invention, and FIG. 4B is an enlarged vies of a main part of the class substrate 50. Hereinafter, the configuration of the glass substrate 50 according to the first embodiment will be described in detail with reference to FIGS. 1 and 2.

In FIG. 4, the glass substrate 59 has a thickness of about 0.7 mm, and is termed in a rectangular shape that has tong and short sides. In a longitudinal direction (main scanning direction) of the glass substrate 50, a plurality of organic electro-luminescent elements 63 used as light emitting elements is arranged in a row. In the first embodiment, organic electro luminescent elements 63 required for the exposure corresponding to a size (210 mm) of at least A4 are arranged in the longitudinal direction of the glass substrate 50, and the sum of the length of the glass substrate 50 in the longitudinal direction thereof and a space required to dispose a drive control unit 58 to be described below is 250 mm. Further, the rectangular glass substrate 50 has been described for the purpose of simplicity of the description in the first embodiment. However, the glass substrate 50 may be modified to have notches at a part thereof so that the glass substrate 50 is positioned when the glass substrate 50 is mounted in the case A 54a.

Reference numeral 58 indicates a driving control unit 58. The driving control unit 58 receives binary image data supplied from the outside of the glass substrate 50, exposure correction data, and control signals such as clock signals or line synchronization signals, and controls the drive of the organic electro-luminescent elements 63 on the basis of these signals. The driving control unit 58 includes an interface part for receiving these signals from the outside of the glass substrate 5C, and an IC chip (resource driver 61) for controlling the drive of the organic electro-luminescent elements 63 on the basis of the control signals received through the interface part.

Reference numeral 60 indicates an FPC (flexible printed circuit) that is used as an interface part for connecting the connector A 53a of the relay substrate 52 with the glass substrate 50. The FPC is directly connected to a circuit pattern (not shown) formed on the glass substrate 50 without connectors or the like. Binary image data, exposure correction data, control signals such as clock signals or line synchronization signals, driving electric power of the control circuit, and driving electric power of the organic electro-luminescent elements 63 used as which emitting elements, which are supplied from the outside of the exposure device 13 as described above, pass through the relay substrate 52, and are then supplied to the glass substrate 50 through the FPC 60.

Reference numeral 63 indicates an organic electron luminescent element, and the organic electro-luminescent element 63 is used as an exposure light source of the exposure device 13. In the first embodiment, 5120 organic electro-luminescent elements 63 are arranged in a row to have a resolution of 600 dpi in the main scanning direction, and respective organic electro-luminescent elements 63 are independently controlled to be turned on and off by a TFT circuit to be described below.

Reference numeral 61 indicates a resource driver provided as an IC chip for controlling the control of the organic electro-luminescent elements 63. The resource driver 61 is flip-chip bonded on the glass substrate 50. A bare chip is used as the resource driver 61 in consideration of surface-mounting thereof on the surface of the glass substrate. Signals relating to the control, such as electric power, clock signals, and line synchrorization signals, and 8-bit exposure correction data are supplied to the resource driver 61. The resource driver 61 is driving current of the organic electro-luminescent elements 63, that is, a drive parameter setting unit. More specifically, the resource driver 61 is used as both an exposure correcting unit and an exposure setting unit. The resource driver 61 sets driving current used to drive respective organic electro-luminescent elements 63 on the basis of the exposure correction data generated by the controller CPU (not shown) provided in the controller 41 (see FIG. 1). The operation of the resource driver 61 based on the exposure correction data will be described in detail below.

The connection portion between the glass substrate 50 and the FPC 6, and the resource driver 61 are connected to each other through, for example, an ITO circuit pattern (not shown) on which metal is formed. Control signals such as exposure correction data, clock signals, and line synchronization signals are input to driving current, that is, the resource driver 61 used as a drive parameter setting unit through the FPC 60. As described above, the FPC 60 used as an interface unit, and the resource driver 61 used as a drive parameter setting unit form the drive control unit 58.

Reference numeral 62 indicates a TFT (Thin Film Transistor) circuit formed on the glass substrate 50. The TFT circuit 62 includes a gate controller (not shown) and driving circuits (not shown). The gate controller, such as a shift register and a data latch unit, controls the time to turn on and off respective organic electro-luminescent elements 63, and the driving circuits (hereinafter referred to as pixel circuits) supply driving current to respective organic electro-luminescent elements 63. One pixel circuit is provided in each of the organic electro-luminescent elements 63, so that the pixel circuits are provided parallel with a light emitting element row formed by the organic electro-luminescent elements 63. Driving current values used to drive respective organic electro-luminescent elements 63 are set in the pixel circuit by the resource driver 61 used as a drive parameter setting unit.

Control signals, such as electric power, clock signals and line synchronization signals, and binary exposure correction data are supplied to the gate controller (not shown) forming the TFT circuit 62 from the outside of the exposure device 13 through the FPC 60. The gate controller (not shown) controls the time to turn on and off respective light emitting elements on the basis of the electric power and signals. The operations of the gate controller (not shown) and the pixel circuit (not shown) will be described in detail below will reference to drawings.

Reference numeral 64 indicates a sealing glass. When the moisture has an effect on the organic electro-luminescent elements 63, shrinkage over time or dark spots occur in the light emitting area For this reason, the light emitting characteristic drastically deteriorates. Therefore, sealing is necessary to block moisture. A sealing method in which a sealing glass 64 is attached to the glass substrate 50 by an adhesive is used in the first embodiment. However, an area corresponding to a distance of about 2000 μm in the sub-scanning direction from the light emitting element row, which is formed by the organic electro-luminescent elements 63, is generally needed as a sealing area. Even in the first embodiment, a distance of 2000 μm is ensured to perform sealing.

Reference numeral 57 indicates an exposure sensor unit used as an exposure detecting section in which a plurality of filmy exposure sensors formed of amorphous silicon is disposed along edges of the glass substrate 50 in the main scanning direction. Reference numeral 59 indicates a processing circuit that includes at least an amplifying circuit and an analogue-digital converting circuit. The exposure sensor unit 57 measures the exposure of the organic electro-luminescent elements 63. When the exposure sensor unit 57 measures the exposure, it is necessary in principle that the organic electro-luminescent elements 63 be individually turned on one-by one so as to measure the exposure. However, the light emission hardly has an effect on the exposure sensors sufficiently spaced apart from the organic electron luminescent elements 63 to be measured (the light emitted from the organic electro-luminescent elements 63 is diminished). For this reason, the exposure sensor unit 57 includes the plurality of exposure sensors in the first embodiment, so that it is possible to measure the exposure of the organic electro-luminescent elements 63 at the same time.

The outputs of the plurality of exposure sensors are input to the processing circuit 59 through wiring lines (not shown). The processing circuit 59 is an analogue-digital mixed IC chip. The output of each of the exposure sensors forming the exposure sensor unit 57 is voltage-converted in the processing circuit 59 by a charge storage method. Then, after being amplified by a predetermined amplification factor, the output is converted from analogue data into digital data. Digital data (hereinafter, referred to as exposure measurement data) after digital conversion is output to the outside of the exposure device 13 through the FPC 60, the relay substrate 52, and a cable 56 (see FIG. 3). As described in detail below, the exposure measurement data is received and processed in the controller CPU (not shown) provided in the controller 41 (see FIG. 1), so that 8-bit exposure correction data is generated.

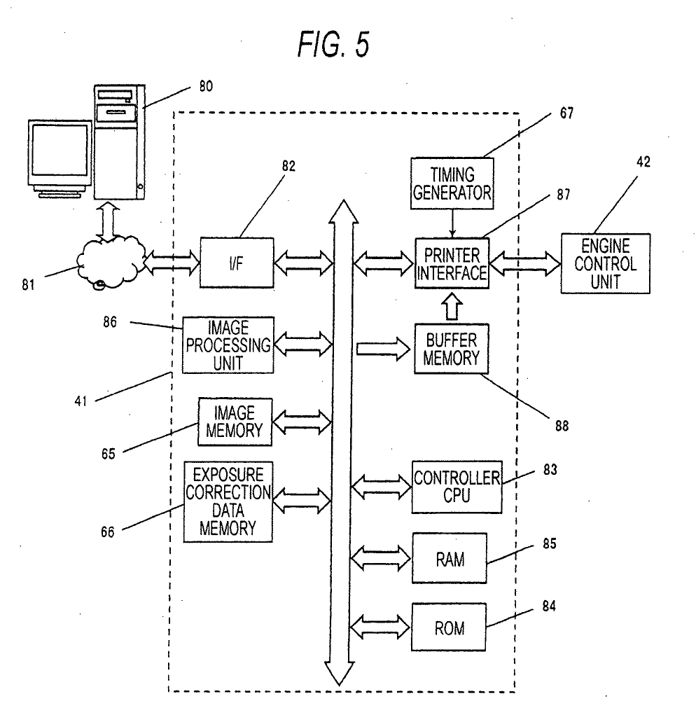

FIG. 5 is a block diagram illustrating the structure of the controller 41 of the image forming apparatus 1 according to the first embodiment of the invention. The operation of the controller 43 will be described below with reference to FIG. 5, and the correction of exposure will also be described in detail below.

In FIG. 5, reference numeral 80 denotes a computer. The computer 80 is connected to a network 81, and transmits image information or print job information on, for example, the number of printed sheets and a print mode (for example, a color or monochromatic mode) to the controller 41 over the network 81. Reference numeral 82 denotes a network interface. The controller 41 receives the image information or the print job information transmitted from the computer 80 through the network interface 82. Then, the controller expands the image information to printable binary image data, and transmits error information detected by the image terming apparatus as so-called status information to the computer 80 over the network 81.

Reference numeral 83 indicates a controller CPU, and the controller CPU 8C controls the operation of the controller 80 on the basis of programs stored In the RON 84. Reference numeral 85 denotes a RAM, and the RAM 85 is used as a work area of the controller CPU 83. The RAM 85 temporarily stores, for example, the image information or the print job information received through the network interface 82.

Reference numeral 86 indicates an image processing unit. The image processing unit 86 performs image processing on each page on the basis of the image information and the print job information transmitted from the computer 80 (for examples the image processing unit 86 performs, for example, an image expanding process, a color correcting process, an edge correcting process, and a screen generating process on each page on the basis of a printer language) to generate printable binary image data, and stores the data in an image memory 65 in the units of pages.

Reference numeral 66 denotes an exposure correction data memory composed of a rewritable non-volatile memory, such as EEPROM.

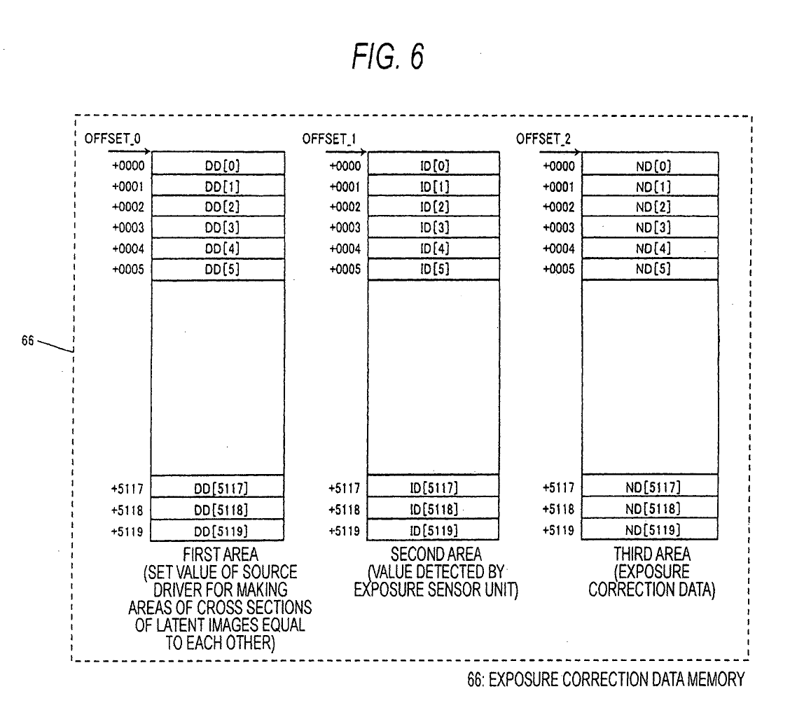

FIG. 6 is a diagram illustrating the content of the exposure correction data memory of the image forming apparatus 1 according to the first embodiment of the invention.

The structure and content of data in the exposure correction data memory will, he described below with reference to FIG. 6.

As shown in FIG. 6, the exposure correction data memory 66 has three areas, that is, first to third areas. Each of the first to third areas includes 5120 8-bit data that is equal to the number of organic electro-luminescent elements 63 (see FIG. 4) forming the exposure device 13 (see FIG. 3) and occupies 15360 bites in total.

First, data DD [[0] to DD [5119] stored in the first area will be described with reference Lo FIGS. 3, 4, and 6.

The above-mentioned exposure device 13 (see FIG. 3) includes a process of adjusting the exposure of the organic electro-luminescent elements 63 (see FIG. 4) forming the exposure device 13 in the manufacturing process thereof. In the process of adjusting exposure, the exposure device 13 is mounted to a predetermine jig (not shown), and the organic electro-luminescent elements 63 are individually turned en in response to control signals supplied from the outside of the exposure device 13.

Further, a CCD camera provided in the jig not shown) measures the two-dimensional exposure distribution of the individual organic electro-luminescent element 63 at the image surface position of the photoreceptor 8 (see FIG. 3). The jig (not shown) calculates the potential distribution of a latent image formed on the photoreceptor 8 on the basis of the exposure distribution, and calculates the area of the cross section of the latent image related to the amount of toner attached, on the basis of the actual developing conditions (development bias value). The jig changes a driving current value for driving the organic electro-luminescent elements 63 (as described above, it is possible to set a current value for driving the organic electro-luminescent elements 63 by programming an analog value in the pixel circuit forming the PFT circuit 62 (see FIG. 41 through the source driver 61) and extracts the driving current value for causing the areas of the cross sections of the latent images formed by the individual organic electro-luminescent elements 63 to be substantially equal to each other, that is, a value set to the pixel circuit (data to be set to the source driver 61 from the viewpoint of control).

When the areas of the emission surfaces of the organic electro-luminescent elements 63 and the amounts of light emitted from the emission surfaces are equal to each other and general developing conditions are considered, the area of the cross section of the latent image is 15 substantially proportional to the amount of exposure. The meaning of ‘the amount of emitted light for a predetermined exposure time’ is the same as that of the amount of exposure’, and the mount of light emitted from the organic electro-luminescent element 63 is generally in 2C proportion to the driving current value (that is, the value set to the pixel circuit). Therefore, the driving current values set to all the pixel circuits are made equal to each other, and then the amounts of light emitted from the individual organic electro-luminescent elements 63 are measured at once, which makes it possible to calculate a value set to the pixel circuit by each organic electro-luminescent element 63 (as described above, data set to the source driver 61;

The data set to the source driver 61 calculated in 5 this way is stored in the first area of the exposure correction data memory 66. As described above, the number of data, 5120, is equal to the number of organic electro-luminescent elements 63 forming the exposure device 13 (that is, which is equal to the number of pixel circuits). The first area of the exposure correction data memory 66 has ‘the set values of the source driver 61 for causing the areas of the cross sections of the latent images formed by the individual organic electro-luminescent elements 63 in an initial state to be equal to each other’ stored therein.

Next, data ID [0] to ID [5119] stored in the second area will be described with reference to FIGS. 3, 4, and 6.

The jig acquires the data stored in the first area and simultaneously acquires 8-bit exposure measurement data through the processing circuit 59 (see FIG. 4) of the exposure device 13 on the basis of the output of the exposure sensor unit 57 (see FIG. 4). In this way, it is possible to acquire ‘exposure measurement data when the areas of the cross sections of the latent images formed by the individual organic electro-luminescent elements 63 in an initial state are made equal to each other’. The 8-bit exposure measurement data ID [r] is stored in the second area.

It is necessary that the driving conditions of the 5 organic electro-luminescent elements 63 when the jig acquires the data ID [n] be the same as those when exposure 5 measured In the first embodiment, as will be described later, one line period (raster period) of the image forming apparatus 1, 350 μs, is applied several times, so that a turn-on period of a total of about 30 ms is given.

In this way, the data stored in the first area and the second area are acquired in the manufacturing process of the exposure device 13, and the data are written from the jig to the exposure correction data memory 66 through an electric communication apparatus (not shown),

Next, data ND [0] to ND [5519] stored in the third area will be described with reference to FIGS. 3, 4, 5, and 6.

In the image forming apparatus 1 according to the first embodiment of the invention includes an exposure correcting unit (the controller CPU 83 (see FIG. 5) for correcting the amounts of exposure of the organic electro-luminescent elements 63 so as to be equal to one another, on the basis of the result measured by the exposure sensor unit 57, serving as an exposure measuring unit. The exposure setting unit sets the amounts of exposure of the organic electro luminescent elements 63 when an image is formed, on the basis of the output of the exposure correcting unit. The set value of the exposure of each of the organic electro-luminescent elements 63 when the controller CPU 83, serving as an exposure correcting unit, forms an image, that is, exposure correction data is written to the third area.

In the image forming apparatus 1 according to the first embodiments as described above, the amounts of exposure of the organic electro luminescent elements 63 forming the exposure device 13 are measured when the image forming apparatus 1 performs an initializing process, when the image forming apparatus 1 starts the image forming apparatus, between sheets, and when the image forming apparatus 1 finishes the image forming process. The controller CPU 83 generates exposure correction data, on the basis of the exposure measurement data measured at these times, and ‘the set value of the source driver 61 for causing the areas of the cross sections of the latent images formed by the individual organic electro-luminescent elements 63 in an initial state to be equal to each other’, and the ‘exposure measurement data when the areas of she cross sections of the latent images formed by the individual organic electro-luminescent elements 63 in an initial state are made equal Lo each other’.

The calculation of the exposure correction data by the controller CPU 83 has been described above. In order to make the point of the invention clear, the invention will be described below assuming that the amount of exposure when the amount of exposure is measured is equal to that when an image is formed.

When ‘the set value of the source driver 61 for causing the areas of the cross sections of the latent images formed by the individual organic electro-luminescent elements 63 in an initial state to be equal to each other’ stored in the first area is DD [n] (n is the organic electro-luminescent element number in the main scanning direction, which is similarly applied to the following description), the ‘exposure measurement data when the areas of the cross sections of the latent images formed by the individual organic electro-luminescent elements 63 in an initial state are made equal to each other’ stored in the second area is ID [n], and exposure measurement data newly measured in, for example, an initializing operation is PD [n] new exposure correction data ND [n] written to the third area is generated by the controller CPU 83 on the basis of the following Expression 1:
ND [n] SD [n]×ID [n]/PD [n] [Expression 1]
(where n is the organic electro-luminescent element number in the main scanning direction)

Expression 1 is a general expression for calculating the exposure correction data. As described above, Expression 1 is applied when the amount of exposure when an image is formed is equal to the amount of exposure when the amount of exposure is measured. In the first embodiment, the amount of exposure of the organic electro-luminescent element 63 when the amount of light is measured by exposure correction as set to be smaller than the amount of exposure when an image is formed. In order to realize this, when the amount of exposure is measured, data obtained by multiplying DD [n] by a rational number ‘k’ smaller than 1 may be used as the exposure correction data to be transmitted to the exposure device 13, and the organic electro-luminescent elements 63 may be turned on, on the basis of the data. For example, data obtained by multiplying the exposure correction data DD [[n] by a rational number of 0.5 is programmed into a pixel circuit (not shown) through the source driver 61 (see FIG. 4), which makes it possible for the organic electro-luminescent element 63 to emit light with an intensity that is half the intensity when an image is formed. At that time, new exposure correction data ND [n] may be generated by the following Expression 2:
ND [n]=DD [n]×(ID [n]×k)/PD [n] [Expression 2]
(where n is the organic electro-luminescent element number in the main scanning direction, and k is a rational number smaller than 1).

The exposure correction data ND [n] generated in this way is written to an area 3 of the exposure correction data memory 66 (see FIG. 5) once. Before an image is formed, the exposure correction data ND [n] is copied from the exposure correction data memory 66 to a predetermined region of the main memory 65 (see FIG. 5). When an image is formed, the exposure correction data ND [n] copied to the main memory 65 is temporarily stored in a buffer memory 88 (see FIG. 5 which will be described later, together with binary image data, and is then output to the engine control unit 42 (see FIG. 5) through a printer interface 87 (see FIG. 5).

The processing circuit 59 (see FIG. 4) performs voltage conversion on the exposure measurement data by a charge storage method. The charge storage method is effective in improving an S/N ratio, but since the output of the exposure sensor forming the exposure sensor unit 57 see FIG. 4) is weak, the charge storage method needs a certain amount of charge storage time. In the first embodiment, the charge storage time is set to about 30 ms, so an S/N ratio of 48 dB is ensured at the time of the measurement of exposure. However, when the charge storage time is set to 30 ms, it takes a lot of time to measure the amount of exposure. It takes 154 seconds to measure the amounts of exposure of 5120 organic electro-luminescent elements 63 (see FIG. 4) (5120×30 ms), which is not practicable. Therefore, in the first embodiment, the exposure sensors forming the exposure sensor unit 57 are composed of 32 amorphous silicon films, and the amorphous silicon films are divided into a group of odd-numbered films and a group of even-numbered films (that is, two groups each composed of 16 exposure sensors. Then, charge storage is simultaneously performed on both the groups, and then the voltages of the exposure sensors are measured, which makes it possible to prevent cross talk between adjacent exposure sensors and to improve a processing speed. In this way, it is possible to measure the amount of exposure in 9.6 seconds A154/16). The structure of the exposure sensor unit 57 will be described in detail later.

This embodiment is continuously, described below with reference to FIG. 5 again.

Reference 88 denotes a buffer memory, and the exposure amount data and the binary image data stored in the main memory 65 are temporarily stored in the buffer memory 88 before they are transmitted to the engine control unit 42. The buffer memory 88 is formed of a dual port RAM in order to absorb the difference between a data transfer rate from the image memory 65 to the buffer memory 86 and a data transfer rate from the buffer memory 68 to the engine control unit 42.

Reference numeral 87 indicates a printer interface. The exposure correction data and the binary image data stored in the main memory 65 in the units of pages are transmitted to the engine control unit 42 through the printer interface 97 in synchronization with a line synchronizing signal or a clock signal generated by a timing generator 67.

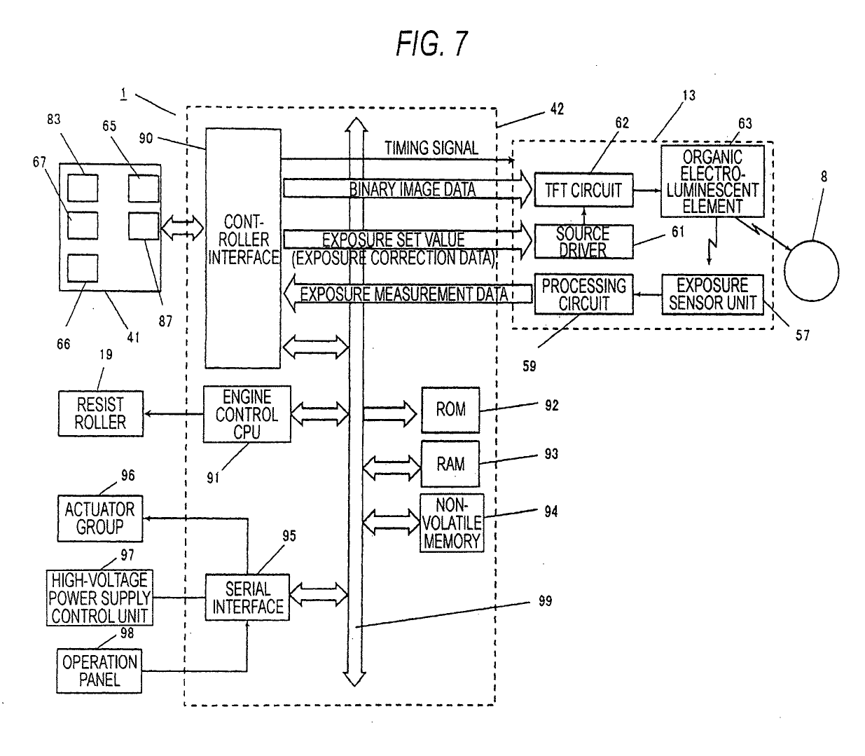

FIG. 7 is a block diagram illustrating the structure of the engine control unit 42 of the image forming apparatus 1 according to the first embodiment of the invention. The operation of the engine control unit 42 will be described in detail below with reference to FIGS. 1 and 7.

In FIG. 7, reference numeral 90 denotes a controller Interface. The controller interface 90 receives the exposure correction data and the binary image data stored in the units of pages from the controller 41.

Reference numeral 91 indicates a control CPU, and the engine control CPU 91 controls the image forming operation of the image forming apparatus 2 on the basis of the programs stored in a ROM 92. Reference numeral 93 denotes a RAM, and the RAM 93 is used as a work area when an engine control CPU 91 operates. Reference numeral 94 is a so-called rewritable non-volatile memory, such as an EEPROM. The non-volatile memory 94 has information related to the life spans of various components, such as the rotation time of the photoreceptor 8 of the image forming apparatus 1 or the operation time of the fixing device 23 (see FIG. 1), stored therein.

Reference numeral 95 denotes a serial interface A serial converting unit (not shown) converts information from a sensor group, such as the recording paper passage detecting sensor 21 (see FIG. 1) or a recording paper rear end detecting sensor 28 (see FIG. 1), or the output of the power monitoring unit 44 (see FIG. 1) into a serial signal having a predetermined cycle, and the converted serial signal is transmitted to the serial interface 95. The serial signal received by the serial interface 95 is converted Into a parallel signal, and is then transmitted to the engine control CPU 91 through a bus 99.

Meanwhile, for example, control signals for an actuator group 96, such as a magnetic clutch (not shown) controlling the transmission of driving force to the paper feed roller 18 (see FIG. 1) and the start/stop of the paper feed roller 18 or the driving source 38, or control signals for a high-voltage power supply control unit 97 for managing the setting of potential, such as a developing bias, a transfer bias, or electrification potential are transmitted to the serial interface 95 as bias signals. The serial interface 95 converts the parallel signal into a serial signal and outputs the converted serial signal to the actuator group 96 ard the high-voltage power supply control unit 97. As described above, in the first embodiment, the serial interface 95 performs the output of an actuator control signal and the input of a signal to the sensor that does not need to be detected at high speed. Meanwhile, a control signal for controlling the driving/stop of the resist roller 19 requiring a relatively high-speed operation is directly output from an output terminal of the engine control CPU 42.

Reference numeral 98 denotes an operation panel connected to the serial interface 95. An instruction input to the operation panel 98 by a user is transmitted to the engine control CPU 91 through the serial interface 95. In the first embodiment, the operation panel, serving as an instruction input unit for inputting the users instruction, is provided, and the amounts of exposure of the organic electro-luminescent elements 63 forming the exposure device 13 are measured, and the amounts of exposure are corrected, on the basis of the instruction input through the operation panel. The instruction may be input from, for example, an external computer through the controller 41. More specifically, for example, in a case in which the wiser finds the irregularity of density on a printed sheet when a large number of sheets are printed, the user may forcibly perform the correction of exposure to improve the quality of a printed matter. When the image forming apparatus 1 is in a standby state, the user can instruct the image forming apparatus to perform the forced exposure correcting process at any time. When forming an image, the user can instruct the image forming apparatus to perform the exposure correcting process by changing the image forming apparatus 1 to an off-line mode to suspend the formation of an image. When the user forces the image forming apparatus to perform the exposure correcting process, it is desirable to rapidly cope with this situation. Therefore, when no image is formed, that is, in the off-line state, the amounts of light emitted from all the organic electro-luminescent elements 63 are measured.

When a request to correct the amount of exposure is input through the operation panel 98, serving as an instructing unit, as described in ‘the initializing operation’, the engine control CPU 91 starts to drive the components of the image forming apparatus 1, and outputs a request to create exposure correcting dummy image information to the controller 41. The controller CPU 83 provided in the controller 11 generate the exposure correcting dummy image information on the basis of the request, and the organic electro-luminescent elements 63 forming the exposure device 13 are turned on or off on the basis of the exposure correcting dummy image information.

In th-s case, the exposure sensor unit 57 provided in the exposure device 13 detects the amounts of exposure of the organic electro-luminescent elements 63 and corrects the amounts of exposure such that the amounts of exposure of the individual organic electro-luminescent elements 63 are equal to each other, on the basis of the result of the detection of the amount of exposure.

Next, an operation of measuring the amounts of exposure of the organic electro-luminescent elements 63 will be described in detail below with reference to FIGS. 1, 5, 6, and 7.

As described above, the amount of exposure is corrected in the initializing operation immediately after the image forming apparatus 1 starts, before printing starts, between sheets, after printing stares, and when the user inputs an instruction through, for example, the operation panel 98. For the purpose of simplicity of explanation, the measurement of the amount of exposure in the initializing operation of the image forming apparatus 1 will be described below. The image forming apparatus 1 according to the first embodiment is configured to form a full color image, and includes the exposure devices 13Y to 13K (see FIG. 1) corresponding to four colors, as described above. However, for the purpose of simplicity of explanation, the operation of the exposure device corresponding to one color will be described, and the exposure device is represented by reference numeral 13. In the following description, the components, such as the driving source 38 (see FIG. 1) and the developing station 2 (see FIG. 2), as described in detail in ‘the initializing operation’, are operated as described above.

In the image forming apparatus 1, the engine control unit 42 manages the image forming operation, and an exposure correcting sequence including the measurement of the amount of exposure is performed by the engine control CPU 91 of the engine control unit 42. First, the engine control CPU 91 outputs to the controller 41 a request to create dummy image information that is different from the regular binary image data related to the formation of an image.

The engine control unit 42 and the controller 41 are connected to a bidirectional serial interface (not shown), so that they can exchange a request command (request) and acknowledge (response information) corresponding to the request commend The request to create the dummy image information made by the engine control CPU 91 is output from the controller interface 90 to the controller 41 through the bus 99 by using the bi-directional serial interface (not shown).

The controller CPU 83 provided in the controller 41 directly creates dummy image information, that is, binary image data used to measure the amount of exposure, in the main memory 65, on the basis of the request. The controller CPU 83 reads out ‘the set value of the source driver 61 for causing the areas of the cross sections of the latent images formed by the individual organic electro-luminescent elements 63 in an initial state to be equal to each other’ DD [n] (n: 0 to 5119) stored in the first area of the exposure correction data memory 66 (see FIG. 6), and multiplies the set value by a constant smaller than 1 (for example, 0.5), thereby setting the amount of exposure of the organic electro-luminescent element 63 to a value that is smaller than the value when a general image forming process is performed. Then, the controller CPU 83 writes the value to a predetermined region of the main memory 65. When these processes are completed, the controller CPU 83 outputs the response information to the engine control unit 42 through the printer interface 87.

The value k used to set the amount of exposure of the organic electro-luminescent element 63 when the amount of exposure is measure is not limited to 0.5 (that is, the amount of exposure when the amount of exposure is measure is set to half the amount of exposure when an image is formed). An object of the invention is to solve the problem that an image formed when light emitted from the organic electro-luminescent elements 63 at the time of the measurement of the amount of exposure is incident to the photoreceptor 8 is displayed. Therefore, in order to achieve the object, it is preferable that the constant k be set to the above-mentioned value. The smaller the constant k becomes, the less the amount of light emitted from the organic electro-luminescent element 63 becomes, which causes the potential of the latent image formed on the photoreceptor 8 to be lowered. As a result, the image is not developed. However, since the value detected by the exposure detecting sensor unit 57 is also small, this is disadvantageous from the viewpoint of the S/N ratio when measuring the amount of exposure. In the actual case, it is necessary to determine the value of the constant k, considering ‘difficult in development’ ard the S/N ratio when the amount of exposure is measured.

Further, it is desirable that the value of the S constant k depends on the position and conditions of the image forming apparatus 1. In particular, the developing characteristics of the image forming apparatus using an electro-photographic method depend on the conditions (temperature and humidity) of the image forming apparatus 1 and the deterioration of the photoreceptor 8 over time. Therefore, for example, it is preferable that the value of the constant k be changed on the basis of a temperature/hymidity sensor (not shown) or information on the life span of the apparatus that is stored in the non-volatile memory 94. It is possible to improve the S/N ratio at the time of measurement by prolonging the chance storage time by using she processing circuit 59 (see FIG. 4). Thus, for example, when the internal temperature of the image forming apparatus 1 is low and it is possible to reduce the number of organic electro-luminescent elements 63 whose exposure amount should be measured between sheets, the constant k can be set to a smaller value, which causes the value of the constantt k to be selected in a wider range.

The engine control CPU 91 of the engine control unit 42 having received the response information directly sets writing timing to the exposure device 13. That is, the engine control CPU 91 sets the writing timing of an electrostatic image by the exposure device 13 to, for example, a timer (not shown), which is hardware, and start the operation of the timer immediately after receiving the response information (this function is originally used to set the start timing of a plurality of exposure devices 13 for every color). In the measurement of the amount of exposure, the precise setting of timing not needed. For example, the timer may be set to zero. When a predetermined time has elapsed, each timer outputs a request to transmit image data to the controller 41. The controller 41 having received the request to transmit image data transmits binary image data to the exposure device 13 through the controller interface 90 in synchronization with the timing signal generated by the timing generating unit 67 (for example, a clock signal and a line synchronizing signal). At the same time, ‘the value of the amount of exposure set to be smaller than that when an image is generally formed’ written to the image memory 65 is also transmitted to the exposure device 13 in synchronization with the timing signal. When an image is generally formed, not when the amount or exposure is measured, the exposure correction data (ND [n] is supplied to the exposure device 13 through the same transmission path, instead of ‘the value of the amount of exposure set to be smaller than that when an image is generally formed’.

The binary image data transmitted in synchronization with the timing signal is input to a TFT circuit 62 of the exposure device 13. At the same time, the set value for the amount of exposure is input to a source driver 61 of the exposure device 13. The exposure device 13 controls the corresponding organic electro-luminescent elements 63 to be turned on or off on the basis of the input binary image data, that is, ON/OFF information. In this case, the organic electro-luminescent elements 63 emit light that is less than the amount of exposure when an image is generally formed, on the basis of the set value for the amount of exposure. The amounts of light emitted from the organic electro-luminescent elements 63 are measured by the exposure sensors forming the exposure sensor unit 57.

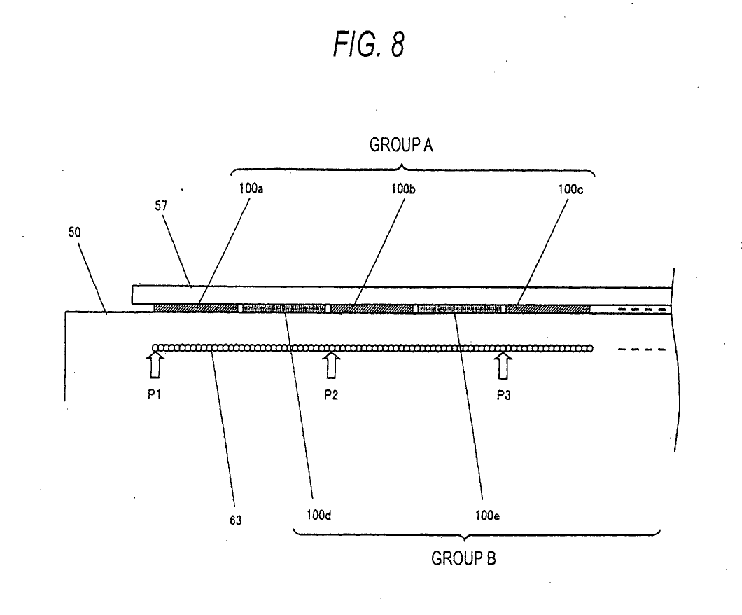

FIG. 8 is a diagram illustrating the positional relationship between the exposure sensors forming the exposure sensor unit 57 and the organic electro-luminescent elements 63 in the image forming apparatus 1 according to the first embodiment of she invention).

In FIG. 8, reference numerals 100a to 100e denote the exposure sensors. Hereinafter, a process of measuring the amount of exposure by using the exposure sensor unit 57 will be described. When the exposure sensors are generally described, the exposure sensors are represented by reference numeral 100.

The organic electro-luminescent elements 63 according to the first embodiment each have a polygonal shape having sides each having a length of about 40 μm or a substantially circular shape. The organic electro-luminescent elements 63 are arranged in a line on the glass substrate 50 at a resolution of 600 dpi, that is, at pitches of 42.3 μm, thereby forming a row of light emitting elements. The exposure sensor unit 57 has 32 rows of exposure sensors 200 each having a width of about 6.5 mm, and is bonded to the end surface of the glass substrate 50 such that the exposure sensors 100 are arranged in parallel to the organic electro-luminescent elements 63 disposed in a row. As described above with reference to FIG. 4, the gab between the row of light emitting elements and the exposure sensor unit 57 is set to 2 m, since the gap needs to be sealed.

As shown in FIG. 8, the exposure sensor unit 57 a group A of exposure sensors 100a, 100b, 100c, . . . , and a group B of exposure sensors 100d, 100e, . . . . When the amounts of exposure of the organic electro-luminescent elements are measured by the exposure sensors 100a, 100b, and 100c belonging to the group A, the exposure sensors 100d and 100e belonging to the group B are separated from the processing circuit 59 (see FIG. 7) by a switching circuit (not shown) composed of TFTs, so that the exposure sensors 100d and 100e are controlled not to measure the amount of exposure. The control process is performed on the basis or the timing signal (see FIG. 7), and is indirectly managed by the engine control CPU 91 of the engine control unit 42 for starting the control process.

Further, the group A measures the amounts of exposure of the group B, and the group 3 measures the amounts of exposure of the group A. When the amount of exposure is measured one group, the exposure sensors 100 of the corresponding group simultaneously measure the amount of exposure. In this case, for example, the amount of exposure of the organic electro-luminescent element 63 formed at a position P1 is measured by the exposure sensor 100a, the amount of exposure of the organic electro-luminescent element 63 formed at a position P2 is measured by the exposure sensor 100b, and the amount of exposure of the organic electro-luminescent element 63 formed at a position P3 is measured by the exposure sensor 100c. In order to make the organic electro-luminescent elements 63 formed at specific positions, such as P1, P2, P3, . . . , the controller 41 (see FIG. 5) creates dummy image information items corresponding to the organic electro-luminescent elements 63 formed at these positions.

Since the exposure sensors 100 forming the group B together with the positions P1, P2, and P3 are arranged among the positions P1, P2, and P3, sufficiently large gaps can be provided among the positions P1, P2, and P3. In this way, light emitted from the organic electro-luminescent element 63 formed at the position P1 reaches the exposure sensors 100b and 100 and are then detected, which makes it possible to sufficiently reduce so-called optical cross talk.

In the measurement of the amount of exposure, the positions of the organic electro-luminescent elements 63 emitting light are discrete. In the electro-photographic method, latent image regions that are continuous with one another in area (particularly, in the main scanning direction) are easily developed. However, when a minute latent image is isolated, the number of power lines is small, which makes it difficult to develop the latent image. In the first embodiment, the position of a latent image is considered to prevent toner from being attached to the photoreceptor 8 when the amount of exposure is measured.

Hereinafter, this embodiment will be continuously described with reference to FIG. 7 again.

The operations of the organic electro-luminescent elements 63 are controlled in the above-mentioned manner, and the amount of exposure is measured by the exposure sensor unit 57. The output (analog current value) of the exposure sensor unit 57 is converted into a voltage by a charge storage method in the processing circuit 59, and is then amplified at a predetermined amplifying rate. Then, the amplified voltage signal is converted into a digital signal, and output from the processing circuit 59 as 8-bit exposure measurement data (digital data).

The exposure measurement data output from the processing circuit 59 is transmitted from the engine control unit 42 to the controller 41 through the controller interface 90, and is then input to the controller CPU 83 of the controller 41. As described with reference to FIGS. 5 and 6, the controller CPU 63 generates light amount correction data ND [n] using the exposure measurement data as PD [n] of Expression 2.

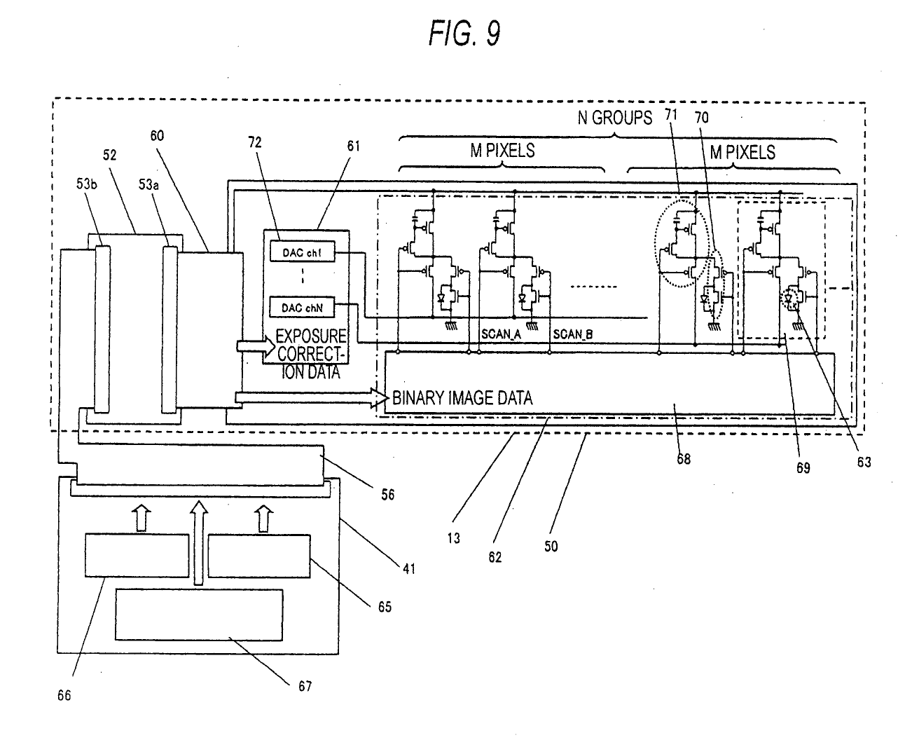

FIG. 9 is a circuit diagram illustrating the exposure device 13 of the image forming apparatus 1 according to the first embodiment of the invention. The lightning control by the TFT circuit 62 and the source driver 61 will be described in detail below with reference to FIG. 9.

The TFT circuit 62 includes pixel circuits 69 and a gate controller 68 as main components. Each of the pixel circuits 69 are provided in the organic electro-luminescent element 63, and N groups each composed of M pixels including the organic electro-luminescent elements 63 are provided on the glass substrate 50.

In the first embodiment, 640 groups each composed of 8 pixels (that is, M is 8) exist. Therefore, the total number of pixels is 5120 (8×640). Each of the pixel circuits 69 includes a driver unit 70 for supplying a current to the organic electro-luminescent element 63 to drive it and a so-called current program unit 71 that stores the current value supplied from the driver (that is, the driving current value of the organic electro-luminescent element 63) in an internal capacitor in order to turn on or off the organic electro-luminescent element 63. The pixel circuit 69 can drive the organic electro-luminescent element 63 at a predetermined timing according to a programmed driving current value.

The gate controller 68 includes a shift register that sequentially shifts input binary image data, a latch unit that Is provided in parallel to the shift register and collectively holds the binary image data after the binary image data is input to a predetermined number of pixels, and a control unit that controls the operational timing of the shift register and the latch (these components are not shown in FIG. 9). The gate controller 68 receives the binary image data (image information converted by the controller 42 when an image is formed and dummy image information converted by the controller 41 when the amount of exposure is measured from the controller 41 and outputs signals SCAN_A and SCAN_B on the basis of the binary image data, that is, ON/OFF information. In this way, the gate controller 68 controls the timing of the period for which the organic electro-luminescent element 63 connected to the pixel circuit 69 is turned on or off and the timing of the current program period for setting the driving current.

Meanwhile, the source driver 61 includes D/A converters 72 corresponding to the number of groups N of organic electro-luminescent elements 63 (in the first embodiment, the number of D/A converters is 640). The source driver 61 sets driving currents for the individual organic electric-luminescent elements 63, on the basis of 8-bit exposure correction data supplied through an FPC 60, In this way, the individual organic electro-luminescent elements 63 are controlled such that the amounts of exposure thereof are equal to each other on the basis of the light amount correction data ND [n ] when an image is formed. When the amount of exposure Is measured, the organic electro-luminescent elements 63 are controlled such that the amounts of exposure thereof are smaller than that when an image is formed.

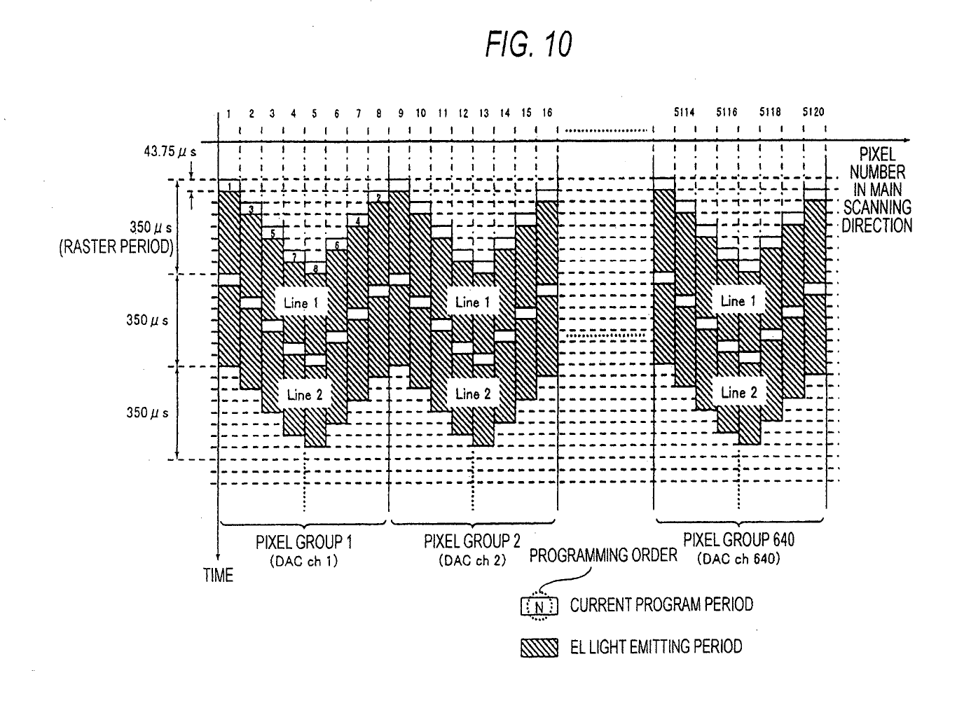

FIG. 10 is a diagram illustrating the turn-on period of ;he organic electro-luminescent element 67 and the current program period of the exposure device 13 in the image forming apparatus 1 according to the first embodiment of the invention. The turn-on control of the first embodiment will be described in detail below with reference to rigs. 9 and 10. For the purpose of simplicity of explanation, one pixel group composed of 8 pixels (for example, pixel numbers i to 8 in the main scanning direction in FIG. 10) will be described below.

In the first embodiment, one line period (raster period) of the exposure device 13 is set to 350 μ is, and one eighth of one line period (43.77 μs) corresponds to a program period for setting a driving current value to a capacitor formed in the current program unit 71.

First, the gate controller 68 (see FIG. 9) changes the signal SCAN_A to an ON state, and changes the signal SCAN_B to an OFF state for pixel number 1, thereby setting the program period in the program period, 8-bit exposure correction data is supplied to the D/A converter 72 provided in the source driver 61 (see FIG. 9), the supplied digital data is converted into an analog signal, and the capacitor of the current program unit 71 (see FIG. 9) is charged by the analog signal The program period Is performed regardless of the ON/OFF state of the binary image data input to the gate controller 68. In this way, an analog value is written to the capacitor formed in the current program unit 71 for every line period, on the basis of 8-bit exposure correction data (a value obtained by multiplying ND [n] shown in FIG. 6 by a constant k smaller than 1 when an image is formed, and a value obtained by multiplying DD [n] shown in FIG. 6 by a constant k smaller than 1 when the amount of exposure is measured). That is, the charge stored in the capacitor of the current program unit 71 is always refreshed, and the driving current of he organic electro-luminescent element 63 determined on the basis of the charge is kept constant.

When the program period has elapsed, the gate controller 68 (see FIG. 9) directly switches the signals SCAN_A and SCAN_B to OFF and ON states, respectively, thereby setting the turn-on period. As described above, the binary image data is supplied to the gate controller 68 (see FIG. 9) when an image is formed or when the amount of exposure is measured. When the image data is an OFF state in the turn-on period, the organic electro-luminescent element 63 is not turned one On the other hand, when the image data is an ON state, the organic electro-luminescent element 63 is kept in an ON state for the remaining period of 306.25 μs is (actually, the light emitting time of the organic electro-luminescent element is slightly shortened due to the switching time of the control signal). As described above, in the first embodiment a measurement time of 30 ms is assumed when the amount of exposure of the organic electro-luminescent element 63 is measured. However, the controller 41 generates dummy image Information such that the switching of the organic electro-luminescent elements 63 to an ON state is performed, for example, one hundred times (that is, 100 lines) when the amount of exposure is measured.

Meanwhile, when the program period for the pixel circuit E9 (see FIG. 9) of pixel number 1 shown in FIG. 10 has ended, -he gate controller 68 (see FIG. 9) directly sets tile current program period to the pixel circuit 69 (see FIG. 9; of pixel number 8. Similar to the procedure for setting the program period to the pixel circuit of pixel number 1, immediately after the setting of the program period to the pixel circuit of pixel number 8 is completed, the turn-on period of the organic electro-luminescent element 63 (see FIG. 9) of she corresponding pixel starts.

In this way, the gate controller 68 (see FIG. 9) sets the program period and the turn-on period to pixel numbers 1, 8, 2, 7, 3, 6, 4, 5 and 1 in the main scanning direction in this order. Since the turn-on timings of the pixels closest to each other in adjacent pixel groups are close to each other, it is possible to make the step difference between images invisible to the human eye by setting the program period and the turn-on period in the above-mentioned order.

The value set to the pixel circuit 69 (see FIG. 9) in the current program period is, for example, 8-bit exposure correction data, as described above. Since the organic electro-luminescent elements 63 (see FIG. 9) are formed by a coating process, such as spin coating, a close relationship is established between adjacent organic electro-luminescent elements 63. Therefore, the brightness of light emitted from a specific organic electro-luminescent element 63 (see FIG. 9) is substantially equal to that of light emitted from another organic electro-luminescent element 63 (see FIG. 9) adjacent thereto. In order to establish a close relationship between exposure correction data of adjacent organic electro-luminescent elements 63 (see FIG. 9), the exposure correction data of pixel number 1 and the exposure correction data of pixel number 8 are not largely changed.

In the Current program period controlled by the gate controller 68 (see FIG. 9), a current value is supplied to the pixel circuit 69 (see FIG. 9) on the basis of the exposure correction data to charge the capacitor of the pixel circuit 69 (see FIG. 9) with a so-called constant current source. Therefore, the time required to charge the capacitor is obtained by the following Expression 3:
t=C×V/ᵢ [Expression 3]
(where C is capacitance, V is potential, and i is a current supplied).

According to Expression 3, the charging time is in proportion to the capacitance. In addition, when the capacitance C becomes large due to an increase in wiring capacitance caused by a long wiring line, the charging time is also lengthened. In the first embodiment, since the source driver is arranged on an extension line of a row of light emitting elements and is also disposed in an end portion of the glass substrate 50 in the lengthwise direction, in the pixel group arranged farthest from the source driver 61 (see FIG. 9,, a delay in charging may occur due to the wiring capacitance.

However, in the first embodiment, since the exposure correction data is supplied by the source driver 61 (see FIG. 9) and the values of the exposure correct,on data are much likely to be equal to each other in one pixel group, the potential V is little changed in the same pixel group (Expression 3). Finally, the charging time depends on the difference between the potentials V of pixel numbers sequentially selected in the current program process, and he difference between the potentials V of the selected pixel numbers is excessively small. Therefore, the charging time is considerably shortened. Thus, in the first embodiment, a short current program period caused by a long wiring line from the source driver 62 (see FIG. 9) does not matter, and the distance between the source driver 61 (see FIG. 9) and the pixel circuit 69 (see FIG. 9) becomes large, as described above.

Therefore, unlike the conventional display device in which the driving current is set to each pixel by a current program method and multi-grayscale display, such as 64 grayscale display or 256 grayscale display, is performed in the units of pixels, the exposure device 13 can control the on/off states of the organic electro-luminescent elements on the basis of binary image data, and set the driving current by using the current program method on the basis of multi-valued exposure correction data.

In the first embodiment, the turn-on times of the organic electro-luminescent elements 63 forming the exposure device 13 are set to be equal to each other and the current value is changed to control the amounts of exposure of the organic electro-luminescent elements 63. However, she invention may be easily applied to a PWM method in which the driving current values of light emitting elements, such as the organic electro-luminescent elements 63, are set to a fixed value and the turn-on time is changed to control the amounts of exposure of the light emitting elements. In this case, the content of the first area described with reference to FIG. 6 may be substituted for ‘the set value of the driving time for making the areas of the cross sections of latent images equal to one another’.

### Second Embodiment

Hereinafter, a second embodiment of the invention will be described. The overall structure of and image forming apparatus 1 according to the second embodiment is similar to that of the image forming apparatus according to the first embodiment except for a peripheral portion of a developing station 2. Therefore, in the second embodiment, a description of the same components as those in the first embodiment will be omitted.

FIG. 1 is a diagram illustrating the periphery of the developing station 2 of the image forming apparatus according to the second embodiment of the invention.

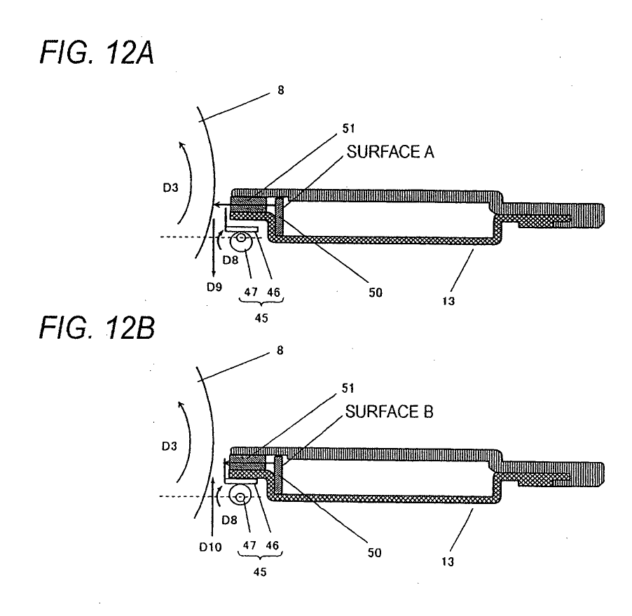

FIG. 12A is a diagram illustrating the state of an exposure device 13 of the image forming apparatus 1 according to the second embodiment of the invention when all image is formed, and FIG. 12B is a diagram illustrating the state of the exposure device 13 of the image forming apparatus 1 according to the second embodiment of the invention when the amount of light is measured hereinafter, the structure of the image forming apparatus 1 according to the second embodiment of the invention will be described with reference to FIGS. 1, and 11, 12A, and 12B.

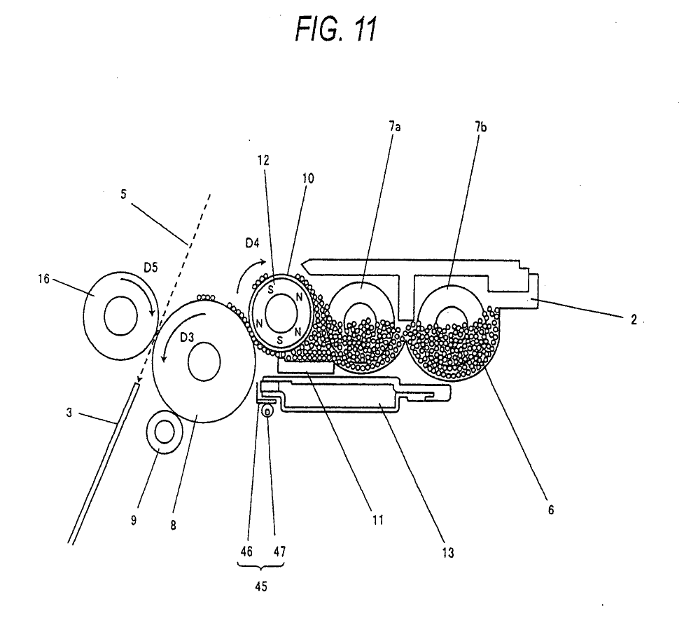

In FIGS. 11, 12A, and 12B, reference numeral 45 denotes an image formation suppressing unit, and the image formation suppressing unit 45 prevents light emitted from organic electro-luminescent elements formed on a surface A of a substrate 50 forming an exposure device 13 from being incident on a photoreceptor 8. The image formation suppressing unit 45 includes a light shielding member 4F and a displacement member 47 for changing the position of the light shielding member 46.

In the second embodiment, the image formation suppressing unit 45 includes the light shielding member 46 that is arranged between an exposure portion (exposure device 13) and the photoreceptor 9 such that t can change the position thereof and shields light emitted from the exposure portion (exposure device 13).

The light shielding member 46 is a plate member formed of, for example, resin, and a black film is attached to one end of the light shielding member 46. The film shields light emitted from the exposure device 13 In the second embodiment, the light shielding member 46 includes the plate member and the black film, but the plate member and the black film may be integrally formed. The color of the film for shielding light is not limited to black. For example, any color film may he used as long as it can physically shield light emitted from the organic electro-luminescent elements 63.

The displacement member 47 is, for example, a metal shaft, and the rotational axis of the displacement member 47 deviates from the center of the metal shaft. The displacement member 47 is supported in a case (not shown) of the image forming apparatus 1 (see FIG. 1) together with the exposure device 13 and the photoreceptor 8. When driving force from the driving source (see FIG. 1) is transmitted to the end of the displacement member 47, the displacement member 47 makes half a rotation in a direction at once by a member, such as a magnetic clutch (not shown). The rotation of the displacement member 47 in the direction D8 causes the position of the light shielding member 46 to be changed in a direction D9 or a direction D10.

As shown in FIG. 12A, the displacement member 47 supports she light shielding member 46 from the lower direction (in the direction D9) when an image is farmed. Light that is emitted front he organic electro-luminescent element 63 formed on the substrate 50 and is then guided by a lens array 51 reaches the photoreceptor 8 without being shielded by the light shielding member 46, so that a latent image is formed on the photoreceptor 8.

Meanwhile, as shown in FIG. 12B, when the amount of light is measured, the displacement member 47 makes half a rotation from the position shown in FIG. 12A in the direction D8 to move the light shielding member 46 upward (in the direction D10). Then, the light guided by the lens array 51 is shielded by the light shielding member 46 and thus dces not reach the photoreceptor 8. As will be described below, the rotation of the displacement member 47 is controlled by an engine control CPU 91.

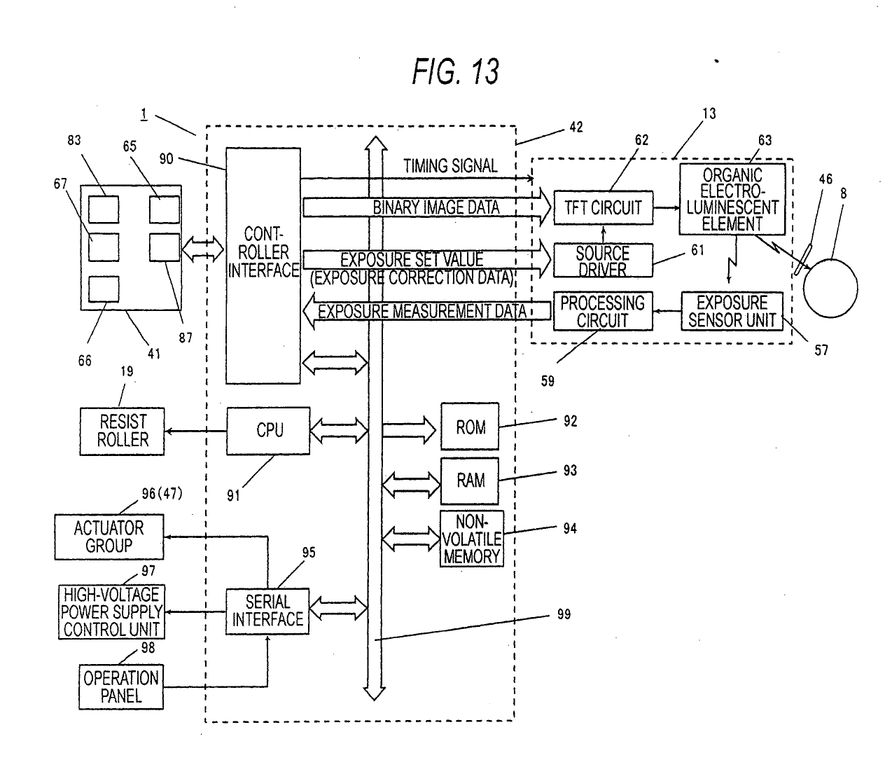

FIG. 13 is a block diagram illustrating the structure of an engine control unit 42 of the image forming apparatus 1 according to the second embodiment of the invention.

Hereinafter, the second embodiment will be continuously described with reference to FIGS. 12 and 13 on the image forming apparatus 1, the engine control unit 42 manages an image forming operation, and the engine control CPU 91 of the engine control unit 42 starts an exposure correcting sequence including the measurement of the amount of exposure. First, the engine control CPU 91 outputs to the controller 41 a request to create dummy image information that is different from the regular binary image data related to the formation of an image.

The engine control unit 42 and the controller 41 are connected to each other by a bidirectional serial interface (not shown), so that they can exchange a request command (request) and acknowledge (response information) corresponding to the request commend. The request to create the dummy image information lade by the engine control CPU 91 is output from the controller interface 90 to the controller 41 through the bus 99 by using the bidirectional serial interface (not shown).

The controller CPU 93 provided in the controller 41 directly creates dummy image information, what is, binary image data used to measure the amount of exposure, in the main memory 65, on the basis of the request. The controller CPU 83 reads out ‘the set value of the source driver 61 for causing the areas of the cross sections of the latent images formed by the individual organic electro-luminescent elements 63 in an initial state to be equal to each other’ DD [n] (n: 0 to 5119) stored in the first area of the exposure correction data memory 66 (see FIG. 6), and sets the amount of exposure of the organic electro-luminescent element 63 to the same value as that when a general image forming process is performed. Then, the controller CPU 83 writes the value to a predetermined region of the main memory 6S. When these Processes are S completed, the controller CPU 83 outputs the response information to the engine control unit 42 through the printer interface 87.

In the first embodiment, when the amount of exposure is measured, the amount of light emitted from the organic electro-luminescent element 63 is set to be smaller than that when an image is formed (as shown in Expression 2, the value of the constant k is smaller than 1). However, in the second embodiment, since the light shielding member 46 is provided, it is unnecessary to intentionally reduce the amount of light emitted from the organic electro-luminescent element 63, and the amount of light emitted from the organic electro-luminescent element 63 may be determined according to Expression 1.

Since light emitted from the exposure device 13 is shielded between the lens array 51 and the photoreceptor 8, the value of the constant k may be set to be larger than 1, and thus the amount of light emitted from the organic electro-luminescent element 63 when the amount of light is measured may be set to be larger than that in the first embodiment and the amount of light emitted from the organic electro-luminescent element 63 when an image is formed. In this way, the amount of light Incident on the light sensor unit 57 (see FIG. 4) increases, which is advantageous from the viewpoint of light receiving sensitivity. As a result, it is possible to improve the S/N ratio when the amount of light is detected.

When preparations for causing the organic electro-luminescent elements 63 emit light are completed, the control CPU 91 rotates the displacement member 47 forming one actuator of an actuator group 96 through the serial interface 95 in the direction E8 to change the position of the light shielding member 46 in the direction D10 such that the black film attached to the light shielding member 46 is arranged between the lens array 51 and the photoreceptor S In this way, the optical path of light emitted from the exposure device 13 is blocked, and thus a latent image due to the measurement of the amount of light is not formed on the photoreceptor 8.

That is, in the second embodiment, the displacement member is formed of a shaft for mechanically changing the position of the light shielding member 46.

In this state, the organic electro-luminescent elements 63 emit light according to the procedure described in the first embodiment, and the light sensor unit 57 (see FIG. 4A) measures the amount of light emitted from each of the organic electro-luminescent elements 63. In this case, since no latent image is formed on the photoreceptor 8, a toner image is not formed on the photoreceptor 8 in the subsequent developing process, which prevents unnecessary waste of toner and also prevents she rear surface of recording paper from being contaminated with toner.

When the measurement of the amount of light is completed, the engine control CPU 91 rotates the displacement member 47 in the direction DS by half through the serial interface 95 so move the light shielding member 46 in the direction D9. That is, the components are arranged in the state shown in FIG. 12A in which light emitted from the exposure device 13 can be incident on the photoreceptor 8, so that a latent image can be formed.

This operation can be performed in the above-mentioned period, such as when the image forming apparatus 1 is initialized, the period between sheets when images are formed on a plurality of sheets, or the period based on user's instructions.

As described above, en the second embodiment, the image forming apparatus includes an exposure portion (exposure device 13) having a row of light emitting elements obtained by forming a plurality of organic electro-luminescent elements 63 in a line, and an image carrier (photoreceptor 8) is exposed by the exposure portion, thereby forming an image. The image forming apparatus according to the second embodiment includes an exposure measuring unit (the exposure sensor unit shown FIG. 4) for measuring the amount of light emitted from the organic electro-luminescent elements 63 and an image formation suppressing unit 45 for preventing an image from being formed on the image carrier (photoreceptor 9) when the amount of light emitted from the organic electro-luminescent elements 63 is measured by the exposure measuring unit.

Further, the image forming apparatus 1 according to the second embodiment includes the photoreceptor 8, and the image formation suppressing unit 45 prevents the exposure portion (exposure device 13) from forming a latent image on the photoreceptor 8.

AR described above, in the second embodiment, the image formation suppressing unit is formed of a shaft which can change its position. However, the image formation suppressing unit 45 may be fixed between the lens array 51 and the photoreceptor 8. In this case, for example, the displacement member 47 is removed from the structure of the image formation suppressing unit 45 shown in FIG. 12A. Therefore, in this case, for example, a shutter (not shown) capable of electrically controlling the transmittance of light, such as a liquid crystal shutter, may be used as the black film for blocking the optical path.

When the image formation suppressing unit 45 is formed of the liquid crystal shutter, the liquid crystal shutter (not shown) may be provided in the exposure device 13 so as to be arranged in a space between the lens array 51 and the substrate. Since the substrate 50 is formed of a smooth and flat material, such as glass, and a surface A and an opposite surface thereof are also smooth and flat, the liquid crystal shutter can be accurately arranged on the substrate 50. When the above-mentioned structure is used, is unnecessary to arrange members on the emission surface of the Lens array, which makes it possible to further reduce the size of the exposure device 13.

### Third Embodiment

Hereinafter, a third embodiment of the invention will be described. The entire configuration of the image forming apparatus 1 according to the third embodiment is substantially the same as that of the image forming apparatus according to the first embodiment, except for the peripheral sections of the developing stations. Therefore, the description of common components will be omitted. In addition, since the control of the image formation suppressing unit 45 is substantially the same as that described with reference to FIG. 13, the description thereof will be omitted.

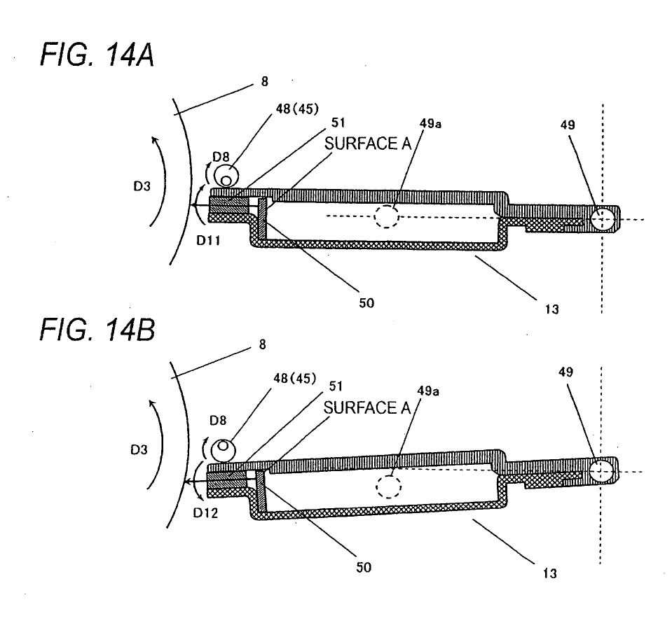

FIG. 14A is a view showing an exposure device 13 of an image forming apparatus according to the third embodiment of the invention when an image is formed, and FIG. 14B is a view showing the exposure device 13 of the image forming apparatus according to the third embodiment of the invention when an amount of light is measured.

Hereinafter, the configuration and operation of an image formation suppressing unit 45 of the image forming apparatus 1 according to the third embodiment of the invention will be described with reference to FIGS. 14A and 14D.

In FIGS. 14A and 1B, reference numeral 48 indicates a light-path length adjusting member that changes a length of the light-path between the exposure section (exposure device 13) and the photoreceptor 8, and the light-path length adjusting member 48 is used as the image formation suppressing unit 45 in the third embodiment.

In the third embodiment, the exposure device 13 is supported so as to be rotated about a supporting shaft 49 in a predetermined range. The light-path length adjusting member 48 is formed of, for example, a metal shaft. The rotary shaft of the light-path length adjusting member 48 is disposed in the metal shaft so as not to be aligned with the center of the metal shaft. The light-path length adjusting member 48 is supported by case A (not shown) of the image forming apparatus 1 (see FIG. 1) so as to be parallel with the exposure device 13, the photoreceptor 8, or the like. Power is transmitted from the driving source 38 (FIG. 1) to the end portion of the light-path length adjusting member 48, so that the light-path length adjusting member 48 is rotated in a D8 direction in a semicircle by a member such as an electromagnetic clutch (not shown). In addition, the exposure device 13 is always pushed against the light-path length adjusting member 48 by basing means such as a spring (not shown), so that the light-path length adjusting member 48 is rotated in the DO direction. As a result, the end portion of the exposure device 13 including the lens array 51 moves in a D11 direction or D12 direction.

As shown in FIG. 14A, when an image is formed, the light-path length adjusting member 48 supports (in the D11 direction) the exposure device 13 upward. Further, the light, which is emitted from the organic electro-luminescent elements 63 formed on the substrate 50 and is guided by the lens array 51, reaches the photoreceptor 8 disposed to have a predetermined positional relationship, so that a latent image is formed on the photoreceptor 8.

Meanwhile, as shown in FIG. 14B, when an amount of light is measured, the light-path length adjusting member 48 is rotated by 180° from the state shown in FIG. 14A, so that the exposure device 13 moves downward (in the D12 direction). That is, in the third embodiment, an angle between the photoreceptor 8 and an axis of the light emitted from the exposure device 13 is chanced, thereby adjusting the length of the light-path. As a result, it is possible to suppress the formation of the latent image on the photoreceptor 8.

As described above, the light guided by the lens array 51 reaches the photoreceptor 8 in the third embodiment. However, when an amount of light is measured, the distance between the lens array 51 and the photoreceptor a is adjusted to be larger than that in FIG. 14A, that is, when an image is formed.

As described above, although the lens array 51 includes rod-shaped lenses (not shown) that are made of plastic or glass and disposed in a row, the light emitted from one organic electro-luminescent element 63 formed on the substrate 50 is emitted in all directions. As a result, the light emitted from one organic electro-luminescent element 63 passes through a plurality of rod shaped lenses and forms an image on the photoreceptor 8. Accordingly, when a focal length is normal, the light from the organic electro-luminescent elements 63 forms one light spot on the photoreceptor 8. However, when a focal length is longer (or shorter) than the normal focal length, the light from one organic electro-luminescent element 63 does net form one light spot. That is, images passing through the plurality of rod-shaped lenses are not focused on one point, and divided into a plurality of light spots.

As described above, when an amount of light is measured, the amount of light from adjacent organic electro-luminescent elements 63 is not measured at the same time. For this reason, an integral effect in which the plurality of light spots overlap each other does not occur, and it is possible to significantly reduce the exposure used to expose the photoreceptor 8.

In addition, the rosary shaft 49 of the exposure device 13 is provided near the end portion of the exposure device 13 in the second embodiment. However, as indicated by reference numeral 49a, the rotary shaft may be provided in the middle of the exposure device 13. The position of the rotary shaft 49 may be set at a proper position so as not to lower the consistency of arrangement of a unit in the image forming apparatus 1.

### Fourth Embodiment

Hereinafter, a fourth embodiment of the invention will be described. The entire configuration of the image forming apparatus 1 according to the fourth embodiment is substantially the same as that of the image forming apparatus according Lo The first embodiment, except for the peripheral sections of the developing stations. Therefore, the description of common components will be omitted. In addition, since the control of the image formation suppressing unit 45 is substantially the same as that described with reference to FIG. 13, the description thereof will be omitted.

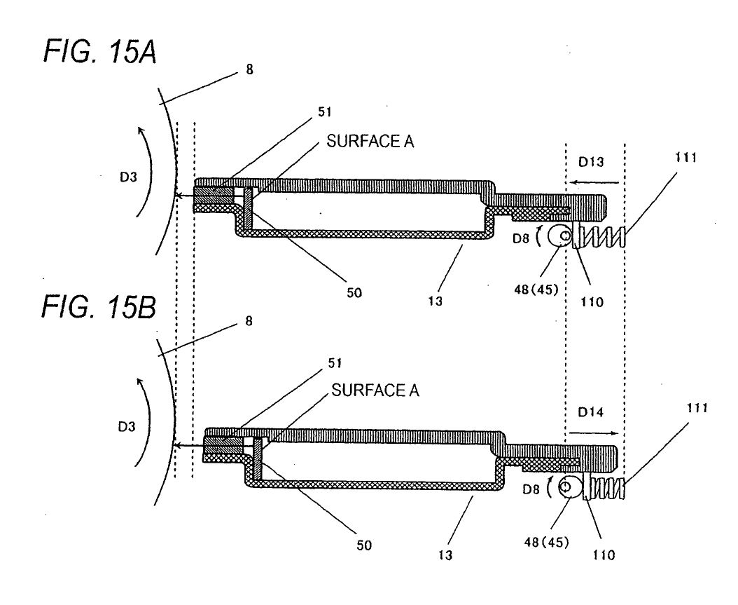

FIG. 15A is a view showing an exposure device 13 of the image forming apparatus according to the fourth embodiment of the invention when an image is formed, and FIG. 15B is a view showing the exposure device 13 of the image forming apparatus according to the fourth embodiment AD of the invention when an amount of light is measured.

Hereinafter, the configuration and operation of an image formation suppressing unit 45 of the image forming apparatus 1 according to the fourth embodiment of the invention will be described with reference to FIGS. 15A and 155.

In FIGS. 15A and 15B reference numeral 48 indicates a light-path length adjusting member that changes a length of the light-path between the exposure section (exposure device 13) and the photoreceptor 8, and the light-path length adjusting member 48 is used as the image formation suppressing unit 45 in the fourth embodiment. Reference numeral 110 indicates a protruding member provided in the exposure device 33, and reference numeral 111 is a biasing member formed of, for example, a spring. The light-path length adjusting member 48 and the biasing member 111 are disposed so as to face each other with the protruding member 100 therebetween.

The light-path length adjusting member 48 is formed of, for example, a metal shaft. The rotary shaft of the light-path length adjusting member 48 is disposed in the metal shaft so as not to be aligned with the center of the metal shaft. The light-path length adjusting member 48 is supported by case A (not shown) of the image forming apparatus 1 (see FIG. 1) so as to be parallel with the exposure device 13, the photoreceptor 8, or the like. Power is transmitted from the driving source 38 (FIG. 1) to the end portion of the light-path length adjusting member 48, so that the light-path length adjusting member 48 is rotated in a D8 direction, in a semicircle, by a member such as an electromagnetic clutch (not shown). In addition, the protruding member 110 fixed to the exposure device 13 is always pushed against the light-path length adjusting member 48 by the biasing member 11, so that the light-path length adjusting member 48 is rotated in the OS direction. As a result, the exposure device 13 moves in a D13 direction or D14 direction.

As shown in FIG. 15A, when an image is formed, the light-path length adjusting member 48 supports a left side (in the D13 direction) of the exposure device 13. Further, the light, which is emitted from the organic electro-luminescent elements 63 formed on the substrate 50 and is guided by the lens array 51, reaches the photoreceptor 8 disposed to have a predetermined positional relationship, so that a latent image is formed on the photoreceptor 8.

Meanwhile, as shown in FIG. 14B, when an amount of light is measured, the light-path length adjusting member 48 is rotated by 1800 from the state shown in FIG. 15A, so that the exposure device 13 moves to a right side (in the D14 direction). That is, in the fourth embodiment, the light-path length adjusting member 48 is configured so as to change a distance between the exposure device 13 and the photoreceptor 8 in an axial direction of the light emitted from the exposure section (exposure device 13).

According to the simple configuration described above, the light emitted from the exposure device 13 forms an image on the photoreceptor 8. As a result, it is possible to suppress the formation of the latent image on the photoreceptor 8.

As described above, the light guided by the lens array 51 reaches the photoreceptor 8 in the fourth embodiment. However, when an amount of light is measured, the distance between the lens array 51 and the photoreceptor 8 is adjusted to be larger than that in FIG. 15A, that is, when an image is formed.

When the distance between the lens array 51 and the photoreceptor is increased during the measurement of an amount of light, due to the same reason as the third embodiment, the light from one organic electro-luminescent element 63 does not form one light spot. That is, images passing through the plurality of rod-shaped lenses are not focused on one point, and divided into a plurality of light spots.

As described above, when an amount of light is measured, the amount of light from adjacent organic electro-luminescent elements 63 is not measured at the same time. For this reason, an integral effect in which the plurality of light spots overlap each other does not occur, and it is possible to significantly reduce the exposure used to expose the photoreceptor 8.

As described above, the configuration and operation of the invention have been described using the first to the fourth embodiments. A so-called tandem color image forming apparatus, which forms an image by using a plurality of developing stations, has been described in these embodiments. However, the invention may also be easily applied to a monochrome image forming apparatus using a single photoreceptor.

In addition, she invention may also be easily applied to an image forming apparatus, which forms a monochrome image on a single photoreceptor several times and then combines the monochrome images by using an intermediate medium as an intermediate transferring body.

Further, there has been known an exposure device 10 that includes light emitting element rows, in which a plurality of light emitting elements are arranged in a row, and exposes substantially the same position of the photoreceptor in the rotation direction thereof several times so as to form a latent image. Even in the exposure device, the spirit of the invention can be applied to set exposure or PWM time so that latent images formed due to being exposed several times are not developed. The latent images for development are not formed in a single light emitting element row of the exposure device. Accordingly, for example, a sequence, in which exposure in a row is measured at a paper interval, may be considered.

Furthermore, in the above-mentioned embodiment, the exposure of organic electro-luminescent elements is measured using the exposure sensor unit provided at the edges of the glass substrate 50 of the exposure device 13. However, the spirit of the invention is net limited thereto. The light transmittance of low temperature silicon forming the TFT circuit 62 is relative high. Accordingly, even in a bottom emission structure that 5 emits exposure light from the glass substrate 50 described in the first embodiment, it is possible to bury an exposure sensor corresponding to each organic electro-luminescent element in each organic electro-luminescent element. In this case, the exposure sensor may be formed on the entire surface directly below a light emitting surface of each organic electro-luminescent element 63, and may be formed so as to correspond to a part thereof.

As described above, although the image forming apparatus using an electro-photographic method has been described in the first embodiment, the invention is not limited thereto. RGB light sources are easily formed of organic electro-luminescent elements. Accordingly, for example, the RGB light sources can be easily applied to an image forming apparatus that includes a plurality of exposure devices including an R light source, a G light source, and a B light source, and directly exposes recording paper on the basis of the image data of red, green, and blue.

As described above, the image forming apparatus according to the invention prevents unnecessary consumption of toner in an electro-photographic apparatus, and effectively prevents the backside of the recording paper from being contaminated with toner. Accordingly, the image forming apparatus according to the invention can be applied to, for example, a printer, a photocopier, a facsimile apparatus, and the like.

This application is based upon and claims the benefit of priority of Japanese Patent Application No2005-289812 filed on May 30, 2003, the contents of which is incorporated herein by references in its entirety.

What is claimed is:

1. An image forming apparatus that includes exposure sections provided with light emitting elements and exposes image carriers by using the exposure sections so as to form images, the apparatus comprising:
an exposure setting unit that sets exposure of the light emitting elements; and
an exposure measuring unit that measures the exposure of the light emitting element,
wherein the exposure setting unit sets the exposure so that the exposure of the light emitting elements when the exposure of the light emitting elements is measured is smaller than the exposure when images are formed.

2. An image forming apparatus that includes photoreceptors as image carriers on which latent images are formed by the exposure of exposure sections, and developing units that develop the latent images formed on the photoreceptors so as to visualize the latent images, the apparatus comprising:
an exposure setting unit that sets exposure of the light emitting elements; and
an exposure measuring unit that measure the exposure of the light emitting elements,
wherein the exposure setting unit sets the exposure so that the exposure of the light emitting elements when the exposure of the light emitting elements is measured is smaller than the exposure used to develop the latent images formed on the photoreceptors.

3. The image forming apparatus according to claim 2,
wherein a bias potential applied to the developing units is turned off In regions of the photoreceptors exposed during a measuring period that measures the exposure of the light emitting elements.

4. The image forming apparatus according to claim 1,
wherein the exposure sections include light emitting element rows in which a plurality of light emitting elements are arranged in a row.

5. The image forming apparatus according to claim 4, further comprising:
an exposure correction unit that corrects the exposure of the light emitting elements so as to be substantially equal to each other on the basis of measurement result of the exposure measuring unit,
wherein the exposure setting unit sets an exposure of each light emitting element when images are formed, on the basis of an output the exposure correction unit.

6. The image forming apparatus according to claim 4,
wherein when the exposure of the light emitting elements is measured, in forming images on a plurality of pages, or a period corresponding to an interval between the respective pages, the exposure of several light emitting elements among the plurality of light emitting elements provided in the exposure sections is measured.

7. The image forming apparatus according to claim 4,
wherein the light emitting elements include organic electro-luminescent elements.

8. The image forming apparatus according to claim 1,
wherein when images are not formed, the exposure of the light emitting elements is measured by the exposure measuring unit.

9. The image forming apparatus according to claim 8,
wherein when images are formed on the plurality of pages, the exposure of the light emitting elements is measured during a period corresponding to an interval between the pages.

10. The image forming apparatus according to claim 8, further comprising;
an instruction input unit that inputs user's instruction,
wherein the exposure of the light emitting elements is measured on the basis of the user's instruction inputted through the instruction input unit.

11. An image forming apparatus that includes exposure sections provided with light emitting element rows in which a plurality of light emitting elements are arranged in a row and exposes image carriers by using the exposure sections so as to form images, the apparatus comprising:
an exposure measuring unit that measures an amount of light emitted from organic electro-luminescent elements; and
an image formation suppressing unit that suppresses formation of the latent images on the image carriers when the exposure measuring unit measure the amount of light emitted from organic electro-luminescent elements.

12. The image farming apparatus according to claim 11,
wherein the image carriers are photoreceptors, and
the image formation suppressing unit suppresses the formation of the latent images, which is performed by the exposure sections, on the photoreceptors.

13. The image forming apparatus according to claim 12,
wherein the image formation suppressing unit is movably disposed between the exposure sections and the photoreceptors, and include light shielding members for shielding the light emitted from the exposure sections

14. The image forming apparatus according to claim 33,
wherein the light shielding members include shutters that move mechanically.

15. The image forming apparatus according to claim 13,
wherein the light shielding members include shutters of which light transmittance is electrically controlled.

16. The image forming apparatus according to claim 12,
wherein the image formation suppressing unit include light-path length adjusting member that changes lengths of the light-paths between the exposure sections and the photoreceptors.

17. The image forming apparatus according to claim 16,
wherein the light-path length adjusting member change distances between the exposure sections and the photoreceptors in a light axial direction of the light emitted from the exposure sections.

18. The image forming apparatus according to claim 16,
wherein the light-path length adjusting member changes angles between the photoreceptors and an axis of the light emitted from the exposure sections.

19. The image forming apparatus according to claim 12, further comprising:
an exposure setting unit that sets an amount of light emitted from the organic electro-luminescent elements,
wherein the exposure setting unit sets the amount of light so that the amount of light emitted from the light emitting elements when the amount of light emitted from the light emitting elements is measured is smaller than the amount of light when images are formed, and suppress the formation of the latent images on the photoreceptors.
